(19) United States
(12) Patent Application Publication
(10) Pub. No.: US 2026/0290312 A1
(43) Pub. Date: Sep. 24, 2026

(54) SYSTEM

(71) Applicant: SoftBank Group Corp., Tokyo (JP)

(72) Inventor: Hirotaka GOTO, Tokyo (JP)

(73) Assignee: SoftBank Group Corp., Tokyo (JP)

(21) Appl. No.: 19/562,850

(22) Filed: Mar. 11, 2026

(30) Foreign Application Priority Data
Mar. 19, 2025 (JP) 2025-044957

(51) Int. Cl. G10L 13/047; G10L 15/16

(52) U.S. Cl. CPC G10L 13/047; G10L 15/16

(57) ABSTRACT

A system includes a processor that is configured to collect, from a database, past message histories and call records of a deceased person, analyze the collected data to extract a speaking tone, expressions, and thinking patterns of the deceased person, construct a generative artificial intelligence model based on the analyzed data, generate a prompt sentence based on input from a user, input the generated prompt sentence into the generative artificial intelligence model to generate a response that mimics the speaking tone of the deceased person, and provide the generated response to the user.

### CROSS-REFERENCE TO RELATED APPLICATION

This application is based on and claims priority under 35 USC 119 from Japanese Patent Application No. 2025-044957 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication systems and memorial services do not adequately reproduce the distinctive speaking tone, expressions, and thinking patterns of a deceased person, even when past digital data such as message histories and call records are available. Existing technologies may simply display stored messages or play back recorded audio, and therefore cannot flexibly generate new, context-appropriate responses that feel as if the deceased person is actively conversing with a surviving user. As a result, the user cannot obtain an interactive experience that realistically reflects how the deceased person would have spoken or responded in a new situation. There is thus a need for a system that can analyze historical communication data of a deceased person, construct a generative artificial intelligence model that captures the deceased person's characteristic speech and thought patterns, and generate responses that mimic the deceased person's speaking tone in accordance with input from the user.

### SUMMARY

In order to solve the above-described problem, a system according to the present invention comprises a processor configured to collect, from a database, past message histories and call records of a deceased person, analyze the collected data to extract a speaking tone, expressions, and thinking patterns of the deceased person, and construct a generative artificial intelligence model based on the analyzed data. The processor is further configured to generate a prompt sentence based on input from a user, input the generated prompt sentence into the generative artificial intelligence model to generate a response that mimics the speaking tone of the deceased person, and provide the generated response to the user. In some embodiments, the processor uses natural language processing techniques to extract features from the message histories and call records of the deceased person, thereby improving the accuracy of the speaking tone, expressions, and thinking pattern extraction. In additional embodiments, the processor generates, based on the input from the user, a prompt sentence that instructs the generative artificial intelligence model regarding a specific conversation theme or situation, thereby enabling the system to produce responses that are adapted to concrete conversational contexts while maintaining the individuality of the deceased person's speech style.

The term “system” refers to an arrangement comprising at least one hardware processor and, optionally, one or more memories, storage devices, communication interfaces, or databases, which cooperate to perform the functions described in the claims.

The term “processor” refers to any hardware circuitry, such as a central processing unit (CPU), graphics processing unit (GPU), application-specific integrated circuit (ASIC), field-programmable gate array (FPGA), or any combination thereof, that executes instructions to perform the described processing.

The term “database” refers to any structured or unstructured data storage system, including local or remote storage, relational databases, NoSQL databases, file systems, or cloud-based data repositories, that stores past message histories and call records.

The term “past message histories” refers to stored records of text-based communications involving the deceased person, including but not limited to messenger application logs, email logs, SMS logs, chat transcripts, and similar digital text exchanges.

The term “call records” refers to stored records associated with voice or video communications involving the deceased person, including but not limited to audio recordings, video recordings, call logs with associated metadata, and any corresponding transcripts.

The term “deceased person” refers to an individual who has passed away and whose past message histories and call records are stored in the database and are used as source data for constructing the generative artificial intelligence model.

The term “analyze” refers to processing the collected data by applying one or more computational techniques, such as parsing, feature extraction, pattern recognition, statistical analysis, or machine learning, in order to derive information used in subsequent steps.

The term “speaking tone” refers to characteristic aspects of the deceased person's manner of speaking, including intonation, formality level, directness, emotional nuance, and typical conversational attitude as inferred from text and call records.

The term “expressions” refers to characteristic words, phrases, idioms, sentence patterns, and stylistic choices that the deceased person frequently used in text messages or spoken utterances.

The term “thinking patterns” refers to characteristic tendencies in the deceased person's reasoning and responses, including typical ways of giving advice, making decisions, expressing opinions, reacting to situations, or structuring arguments.

The term “generative artificial intelligence model” refers to a machine learning model, such as a neural network-based language model or other generative model, that is trained or configured to generate new text responses based on input prompts and learned features.

The term “construct a generative artificial intelligence model” refers to training, fine-tuning, configuring, or otherwise preparing a generative artificial intelligence model using the analyzed data so that the model reflects the speaking tone, expressions, and thinking patterns of the deceased person.

The term “input from a user” refers to information provided by a living user through an input interface, including but not limited to text input, voice input that is converted to text, or selection of options that define a desired conversational theme or situation.

The term “prompt sentence” refers to a text string or structured textual instruction generated by the processor, which is provided as input to the generative artificial intelligence model to control or guide the content, style, and context of the model's output.

The term “generate a prompt sentence” refers to creating, formatting, or assembling one or more text strings that encode at least the user's input, and optionally additional instructions regarding style, theme, or context, for use as input to the generative artificial intelligence model.

The term “response that mimics the speaking tone of the deceased person” refers to output text generated by the generative artificial intelligence model that is intended to resemble the deceased person's characteristic speaking tone, expressions, and thinking patterns, as derived from the analyzed data.

The term “provide the generated response to the user” refers to outputting the generated response to a user-facing interface, including but not limited to displaying the text on a screen, sending the text to a client device, or using the text as a basis for synthesized speech presented to the user.

The term “natural language processing techniques” refers to computational methods and algorithms for processing human language, including but not limited to tokenization, part-of-speech tagging, semantic analysis, sentiment analysis, dialog act recognition, and feature extraction for machine learning.

The term “features” refers to data elements or numerical representations derived from the message histories and call records, including but not limited to linguistic features, semantic features, stylistic features, and statistical patterns, which are used to model the deceased person's speech and thought characteristics.

The term “specific conversation theme or situation” refers to a particular topic, scenario, context, or role-play setting specified directly or indirectly by the user, such as “discuss work-related stress,” “talk about a family event,” or “give advice about a problem,” which the prompt sentence uses to guide the generative artificial intelligence model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

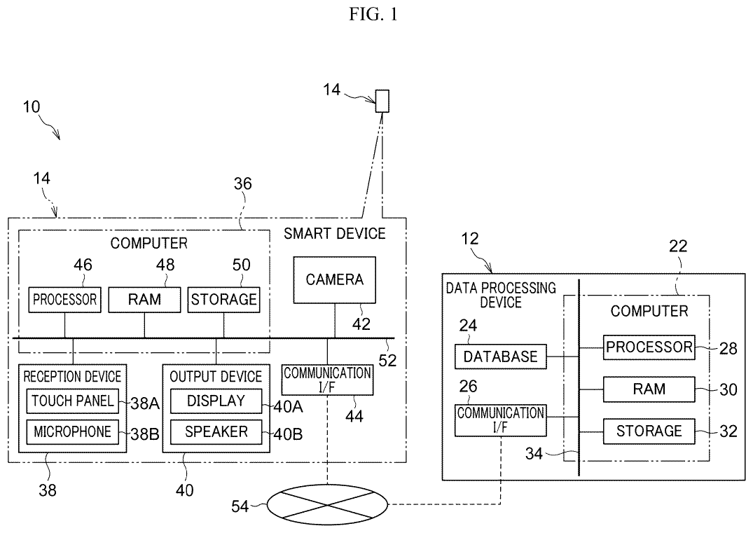

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

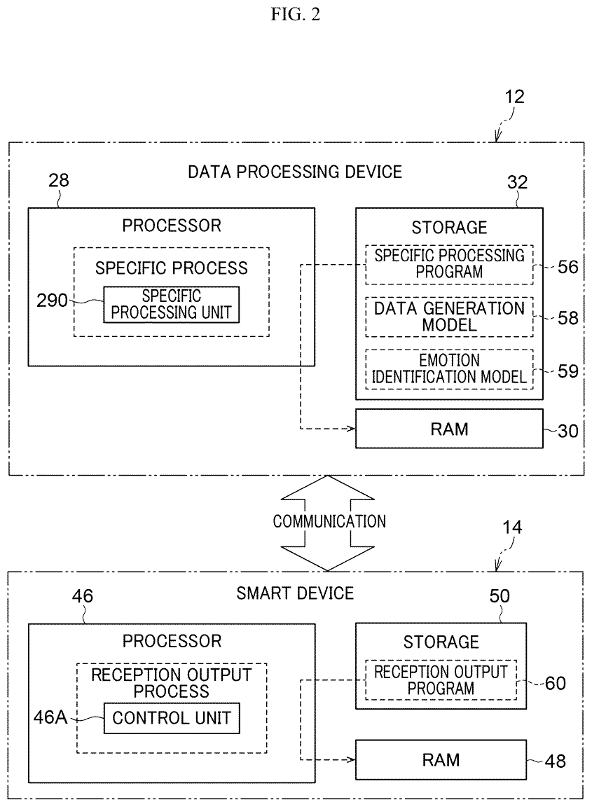

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that imitate a specific person's way of speaking typically fine-tune a generic language model with a limited amount of text data. Such systems often ignore heterogeneous communication records, such as mixed text and audio histories, and treat all utterances as flat sequences of tokens without robust conversation-level structure. As a result, these systems fail to capture conversation-unit context, speaker-role separation, or long-term response patterns, and thus generate responses that only superficially resemble the target person's style.

Moreover, existing systems generally do not model the relationship between linguistic features and acoustic features in an integrated manner. Audio recordings, when used at all, are frequently processed as mere signal samples for generic voice cloning, independent of the specific lexical and conversational tendencies of the target speaker. This disjoint processing leads to inconsistencies between the generated text and the generated audio and increases computational overhead due to redundant or unstructured processing pipelines.

Additionally, prompt sentences for generative artificial intelligence models in conventional systems are often manually crafted and lack explicit, machine-readable constraints regarding conversation topic, situation context, response length, style level, or topic range. Without systematic generation and control of such prompt sentences, the underlying generative model cannot reliably produce context-appropriate outputs that adhere to the target speaker's distinctive expression style. This results in unstable output quality and inefficient use of computing resources, because generation may produce excessively long, off-topic, or stylistically inappropriate responses that must be filtered or regenerated.

Furthermore, known architectures typically perform training and inference as loosely connected modules. Preprocessing, feature extraction, model construction, prompt generation, and response generation are not orchestrated as an integrated, conversation-aware pipeline operating over structured data. This fragmentation complicates implementation, makes it difficult to reuse dialogue history as structured machine-readable context, and limits scalability when applied to large volumes of multi-modal records.

Accordingly, there is a need for an improved computer-implemented system and method that: (i) normalizes heterogeneous communication records into conversation-unit and speaker-unit structured data; (ii) extracts and models speaker feature data that jointly reflect lexical tendencies, sentence structure patterns, response patterns, and acoustic characteristics; (iii) constructs a generative artificial intelligence model whose parameters are specifically adjusted to a target speaker's expression style; and (iv) automatically generates and controls prompt sentences with explicit generation conditions, thereby improving the technical performance, controllability, and efficiency of computer-based generation of responses that imitate a target speaker.

The specific processing by the specific processing unit 290 of the data processing device 12 in Example 1 is realized by the following means.

The present invention provides a server comprising a processor configured to acquire, from a user terminal, communication record data including communication history information and audio record information of a target speaker, to normalize the communication record data into structured data on a conversation basis and a speaker basis and store the structured data in a storage device, to execute natural language processing and audio signal processing on the structured communication record data to extract speaker feature data including lexical selection tendencies, sentence structure patterns, response patterns, and audio feature quantities specific to the target speaker, to construct, by using the speaker feature data and a pre-trained language generation model, a generative artificial intelligence model whose parameters are adjusted so as to conform to an expression style of the target speaker and store the generative artificial intelligence model for response generation processing, to generate a prompt sentence including at least one of a conversation topic, situation information, and constraint information indicating a target speaker style based on a natural language input sentence acquired from the user terminal, to input the generated prompt sentence to the generative artificial intelligence model and generate a text response sentence that imitates the expression style of the target speaker by autoregressively generating tokens by the generative artificial intelligence model, to generate an audio response signal based on the text response sentence by using an audio synthesis model and a waveform generation model that reflect the audio feature quantities of the target speaker, and to transmit at least one of the text response sentence and the audio response signal to the user terminal and record the transmitted information as dialogue history information. This enables improved computer operation in which heterogeneous communication records are converted into machine-efficient structured representations, a generative artificial intelligence model is technically specialized and controlled to reproduce a target speaker's style under explicit generation conditions, and response generation accuracy, consistency between text and audio, processing efficiency, and controllability of dialog behavior are enhanced beyond those achievable by conventional systems.

The term “processor” refers to a hardware computation unit, such as a central processing unit or graphics processing unit, configured to execute program instructions for performing data acquisition, data processing, model construction, and response generation.

The term “user terminal” refers to an information processing device, such as a mobile device, a portable computer, or a stationary computer, operated by a user and configured to transmit input data to a server and receive generated responses from the server.

The term “communication record data” refers to electronically stored data representing past communications, including at least text-based communication history information and audio record information associated with one or more speakers.

The term “communication history information” refers to text-based records of past communications, including, for example, message logs, chat histories, and metadata such as timestamps, conversation identifiers, and speaker identifiers.

The term “audio record information” refers to digitally stored audio signals corresponding to spoken utterances, such as voice messages, recorded calls, or other speech recordings associated with a speaker.

The term “target speaker” refers to an individual person whose expression style, including lexical, structural, and acoustic characteristics, is to be modeled and imitated by a generative artificial intelligence model.

The term “structured data on a conversation basis and a speaker basis” refers to data that is organized into units corresponding to conversation segments and speaker roles, such that each unit is associated with information indicating a conversation context and an identified speaker.

The term “storage device” refers to a non-transitory computer-readable medium, such as a magnetic storage device, a semiconductor storage device, or an optical storage device, configured to store structured data, models, and generated responses.

The term “natural language processing” refers to automated processing applied to human language text, including at least tokenization, sentence segmentation, and semantic or pragmatic analysis, for extracting machine-usable linguistic features.

The term “audio signal processing” refers to automated processing applied to audio signals, including at least loading, resampling, feature extraction, and analysis of acoustic characteristics, for obtaining machine-usable audio features.

The term “speaker feature data” refers to data representing characteristics of a target speaker, including at least lexical selection tendencies, sentence structure patterns, response patterns, and audio feature quantities derived from the speaker's communication record data.

The term “lexical selection tendencies” refers to statistical or learned patterns indicating how frequently and in what contexts a target speaker uses particular words, phrases, or expressions.

The term “sentence structure patterns” refers to structural characteristics of sentences used by a target speaker, including, for example, typical word order, clause arrangement, and punctuation usage.

The term “response patterns” refers to characteristic ways in which a target speaker tends to respond to certain conversational inputs, including typical response lengths, degrees of formality, and common rhetorical or pragmatic structures.

The term “audio feature quantities” refers to numerical values representing acoustic properties of speech, including, for example, spectral features, pitch contours, energy distributions, and temporal characteristics extracted from audio record information.

The term “pre-trained language generation model” refers to a machine-learned model that has been previously trained on a large corpus of text to generate natural language outputs and is further adapted to a target speaker using additional training data.

The term “generative artificial intelligence model” refers to a machine-learned model, such as a neural network-based language model, configured to generate natural language text in response to an input, and whose parameters can be adjusted based on training data.

The term “parameters adjusted so as to conform to an expression style of the target speaker” refers to model parameters that have been updated by training or fine-tuning such that outputs generated by the model statistically approximate the lexical, structural, and stylistic characteristics observed in the target speaker's communication record data.

The term “response generation processing” refers to processing in which a generative artificial intelligence model receives one or more inputs, including a prompt sentence, and outputs a generated response in text form or as an intermediate representation for further processing.

The term “prompt sentence” refers to an input sentence or sequence of tokens supplied to a generative artificial intelligence model, the prompt sentence including information such as a conversation topic, situation information, or stylistic constraints that guide the content and style of the generated response.

The term “conversation topic” refers to information indicating a subject matter or theme of a dialogue, such as a particular event, object, or situation to be addressed in a generated response.

The term “situation information” refers to contextual information describing circumstances of a dialogue, including, for example, temporal context, relationship context, or environmental context relevant to generation of a response.

The term “constraint information indicating a target speaker style” refers to data included in or associated with a prompt sentence that specifies stylistic conditions, such as formality level, emotional tone, or persona attributes, intended to restrict or guide the output of the generative artificial intelligence model toward the style of the target speaker.

The term “autoregressively generating tokens” refers to a generation process in which a model outputs a sequence of discrete symbols one at a time, each symbol being generated based on previously generated symbols and any conditioning inputs.

The term “text response sentence” refers to a natural language sentence or sequence of sentences generated by a generative artificial intelligence model in response to a prompt sentence.

The term “audio synthesis model” refers to a machine-learned model configured to transform textual or intermediate acoustic representations into more detailed acoustic features suitable for wave generation.

The term “waveform generation model” refers to a machine-learned model, such as a neural vocoder, configured to generate a time-domain audio signal from an acoustic representation such as a spectrogram.

The term “audio response signal” refers to a digital audio signal generated by the audio synthesis model and the waveform generation model, the audio response signal representing synthesized speech associated with a generated text response sentence.

The term “dialogue history information” refers to stored data representing past exchanges between a user and the system, including at least prompt sentences, generated responses, timestamps, and optionally associated audio data.

The term “generation conditions” refers to one or more parameters or constraints, including response length, style level, and topic range, that are applied to control output behavior of a generative artificial intelligence model during response generation.

The term “response length” refers to a constraint indicating a desired or maximum size of a generated response, expressed in units such as number of tokens, number of words, or number of sentences.

The term “style level” refers to a constraint specifying a degree of formality, politeness, or other stylistic dimension for a generated response, such as casual, neutral, or formal.

The term “topic range” refers to a constraint defining a scope of subject matter that a generated response is allowed or encouraged to address, for example, limiting the response to a particular domain or excluding certain topics.

In one embodiment, a server, a terminal, and a user cooperate to implement the invention. The server includes at least one hardware processor, a main memory, and a non-transitory storage device such as a solid-state drive. The server is connected to a communication network and executes application programs written, for example, in a high-level programming language such as a scripting language running on an operating system. The server further runs a machine learning framework, such as a tensor computation library or a tensor-based deep learning framework, to construct and execute a generative AI model. The terminal is an information processing device, such as a smartphone or a personal computer, executing a client application or a web browser. The user operates the terminal to provide data and prompt sentences, and to receive generated responses.

The server executes a set of software modules that correspond to functional components of the claimed system. These modules include at least a data acquisition module, a preprocessing module, a feature extraction module, a model construction module, an inference module, and a dialogue management module. Each module is implemented by executable instructions stored in the storage device and loaded into memory, and is executed by the processor. The modular separation enables optimization of memory access patterns, concurrent task scheduling, and caching of intermediate data structures, which improves processing speed and resource utilization compared to a monolithic implementation.

The server acquires, from the terminal, communication record data that includes communication history information and audio record information of a target speaker. The terminal reads local message logs and audio recordings using operating system APIs for file access and media handling, and transmits them via a secure communication protocol to the server. The communication history information may be represented as text messages with associated timestamps and speaker identifiers. The audio record information may consist of digital audio files encoded in a standard format. The server stores the received raw files in a storage device and registers associated metadata, such as user identifiers, file paths, and upload times, in a database.

The server normalizes the communication record data into structured data on a conversation basis and a speaker basis. For this purpose, the server uses a preprocessing module implemented with a data frame library to parse text logs and align each message with its conversation identifier and speaker identifier. The server represents messages using a structured data format, in which each record includes at least a conversation ID, a speaker ID, a timestamp, and text content. The server groups records by conversation ID to form ordered conversation sequences, and within each sequence distinguishes between utterances of the target speaker and utterances of other participants.

The server processes audio record information using a digital signal processing library. The server loads each audio file, resamples it to a unified sampling rate, and converts it to a single-channel representation. The server may segment the audio based on silence detection or existing timestamp annotations, and associates each segment with the corresponding conversation segment in the structured text data. The server then computes numerical acoustic features, such as spectral coefficients, energy measures, and pitch-related quantities, for each segment, and stores these in an indexed feature store. By aligning the text-based conversation structure with the audio feature sequences, the server creates a multi-modal representation of the target speaker's communication style.

The server executes natural language processing on the structured communication record data. The server applies tokenization, sentence segmentation, and part-of-speech tagging using a language processing library. The server also performs dialogue context extraction by identifying message threads, reply-to relations, and local context windows. In one embodiment, the server constructs training pairs consisting of a context sequence (one or more preceding messages in a conversation) and a target sequence (the response message from the target speaker). The server further assigns metadata such as sentiment labels, politeness levels, or formality indicators to target speaker messages using a classification model trained on annotated data. These additional labels form part of the speaker feature data. The server extracts speaker feature data by aggregating statistics and learned representations over the structured data. For lexical selection tendencies, the server computes frequency distributions of tokens and n-grams in the target speaker's utterances and compares them to background language distributions. For sentence structure patterns, the server analyzes syntactic dependency structures or part-of-speech tag sequences, and computes characteristic patterns such as typical clause ordering and recurrent phrase templates. For response patterns, the server examines relationships between context utterances and subsequent target speaker responses to determine typical lengths, delay patterns, and preferred rhetorical structures. The server stores these features as vectors, matrices, and probability distributions associated with the target speaker.

The server uses audio signal processing results to construct audio feature quantities for the target speaker. These quantities include, for example, average and variance of pitch, typical speech rate, and characteristic spectral patterns. The server may also learn speaker embeddings using a neural network that maps audio segments into a fixed-dimensional representation. These embeddings capture speaker-specific vocal characteristics and are stored as part of the speaker feature data. By combining lexical, structural, response-related, and acoustic features into a unified data structure, the server enables subsequent models to condition their outputs on a richer representation of the target speaker than is possible with text-only or audio-only approaches.

The server constructs a generative AI model by fine-tuning a pre-trained language generation architecture using the speaker feature data. In one embodiment, the server uses a transformer-based decoder network with multiple attention layers, layer normalization, and positional encodings. The server initializes this network with parameters obtained from training on a large generic corpus and then performs additional training on the structured conversation data of the target speaker. During fine-tuning, the server uses training pairs of context and target sequences. The loss function may be a cross-entropy loss over the predicted token distribution versus the true tokens in the target sequence. The server updates model weights using a gradient-based optimization algorithm such as adaptive moment estimation, with learning rate scheduling and gradient clipping.

To incorporate the speaker feature data directly into the generative AI model, the server can adopt several mechanisms. In one variant, the server augments each input token sequence with a special style token or embedding that encodes the target speaker identifier and style attributes. In another variant, the server adds an auxiliary input vector representing aggregated speaker features into specific layers of the transformer via concatenation or addition, so that attention computations are modulated by the target speaker characteristics. The server may also use multi-task learning, where the model simultaneously predicts the next token and a style label, and the combined loss encourages preservation of the target speaker's style during generation. These architectural choices result in a model that uses high-dimensional feature vectors and non-linear transformations, which cannot be easily replicated by simple rule-based systems or manual templates.

The server stores the fine-tuned generative AI model in a model repository on the storage device. At runtime, the server loads the model into main memory and, when available, into a specialized processing unit such as a graphics processing unit to accelerate matrix multiplications and attention computations. The server also loads a tokenizer consistent with the model's training. To improve memory locality and reduce communication overhead between processing units, the server may partition model parameters into contiguous memory regions and pre-allocate input and output buffers for batched inference. This hardware-conscious organization of model execution improves throughput and latency when serving multiple inference requests.

The server constructs an audio synthesis pipeline to generate audio response signals corresponding to text response sentences. In one embodiment, the server uses a sequence-to-sequence acoustic model that maps token sequences or phoneme sequences to acoustic feature sequences. The server conditions this model on speaker embeddings extracted from the target speaker's audio features, so that the generated acoustic patterns resemble the target speaker's voice. The server then uses a waveform generation model, such as a neural vocoder, that converts the acoustic feature sequences to time-domain waveforms. Both the acoustic model and the vocoder are trained or fine-tuned using a loss function that measures discrepancies between generated and real audio, such as mean squared error in the spectrogram domain and adversarial loss terms. The server deploys this pipeline on the same or coordinated hardware as the language model to enable combined text-and-audio response generation.

The terminal provides a user interface for the user to supply input and receive output. The terminal displays one or more text input fields in which the user can enter prompt sentences. The user may, for example, input a prompt sentence such as:
“Please talk about today's weather as if you were sending a message to a close friend, in the same style as the deceased used.” or
“Please write a short encouraging message about starting a new job, in the style of the deceased.”

The terminal transmits the prompt sentence and optional parameters such as desired response length or style level to the server. The terminal receives the generated text response sentence and, when applicable, a link or binary stream for the audio response signal. The terminal then displays the text in a chat-like interface and plays the audio through local speakers or headphones.

The server generates a prompt sentence for the generative AI model based on the user's input and system-level constraints. The server may prepend or append tokens representing conversation topic, situation information, and generation conditions such as response length, style level, and topic range. For example, if the user does not explicitly specify response length, the server can include a default length indicator derived from the target speaker's typical response distribution stored in the speaker feature data. The server thereby transforms an unconstrained natural language prompt into a structured prompt sequence that includes control tokens. This structured prompt ensures that the generative AI model receives well-defined conditions during inference, which enhances controllability and consistency of the generated outputs.

The server performs inference by converting the prompt sentence into token IDs using the tokenizer and feeding them into the generative AI model. The model executes its layers in sequence on the processor or hardware accelerator. At each decoding step, the model computes attention scores over previous tokens and speaker feature embeddings, then produces a probability distribution over possible next tokens. The server applies a decoding strategy such as top-k sampling or nucleus sampling with thresholds selected to balance diversity and fidelity to the target speaker's style. Because the server has encoded generation conditions and speaker features as inputs to the model, the probability distribution is already biased toward outputs that match the specified style and constraints, thereby reducing the need for post-processing filters and improving computational efficiency.

From a technical perspective, the server's combination of structured conversation data, integrated multi-modal speaker feature data, and controlled generative AI model execution improves computer technology itself. By normalizing raw communication record data into conversation-based and speaker-based structures, the server reduces data redundancy and allows efficient indexing and retrieval. This structured representation enables the server to construct training batches that preserve long-range dialogue context, improving model convergence and reducing the number of training epochs required to achieve a given performance level. The introduction of explicit generation conditions as part of the prompt sentence allows the server to limit the search space during decoding, which reduces the average number of tokens generated and thus reduces computational load and response time. In addition, the server's approach of jointly using lexical, structural, and acoustic features for model conditioning results in more accurate and stable imitation of the target speaker. Because the generative AI model is explicitly conditioned on speaker feature vectors and style tokens, the model can achieve a similar stylistic match with fewer generated samples and less manual curation. This reduces storage and bandwidth usage for repeated interactions. The management of dialogue history information as structured records also allows the server to cache intermediate model states across turns in a conversation, further reducing redundant computation and improving latency.

The server performs data operations and computations in ways that are distinct from conventional human practice. Human authors cannot feasibly compute and maintain high-dimensional speaker embeddings, cross-entropy gradients, or attention weights for each token; nor can they manually adjust model parameters using gradient descent based on millions of training examples. The server uses a set of non-intuitive, specialized rules for data flow, such as batching of heterogeneous conversation segments, selective masking of tokens in attention layers, and conditional inclusion of side information vectors. These processing rules are designed to exploit parallel processing and optimized linear algebra libraries, and thereby provide measurable improvements in speed, accuracy, and resource utilization over naive or manual approaches.

Alternative embodiments may vary the model architectures and feature representations. In one alternative, the server uses a recurrent neural network with gated units instead of a transformer, while still conditioning the network on speaker feature embeddings and structured dialogue contexts. In another alternative, the server uses a convolution-based encoder to compress long conversation histories into a fixed-size vector, which is then fed as global context to the decoder. In yet another variant, the server uses different loss functions, such as label smoothing or auxiliary contrastive losses, to improve robustness of the generative AI model. These variations still operate within the framework of structured conversation data, explicit speaker feature data, and controlled prompt sentences. The invention is not limited to any particular hardware platform or software library. For example, the server can use different machine learning frameworks, database systems, or network protocols, as long as the server implements the core operations of structured data normalization, speaker feature extraction, generative AI model construction, prompt sentence generation with generation conditions, and controlled response generation. Likewise, the terminal can be implemented as a native application, a web application, or a hybrid application, provided that the terminal transmits user inputs to the server and receives outputs from the server.

By integrating these elements, the system enables a concrete improvement in computer-based dialogue generation. The server's processing pipeline transforms heterogeneous, unstructured communication record data into optimized internal representations and controls a generative AI model using explicit machine-readable constraints embedded in prompt sentences. This design leads to more efficient training and inference, better consistency between text and audio outputs, and improved precision in reproducing a target speaker's style, thereby achieving technical effects that extend beyond a mere automation of human editorial work.

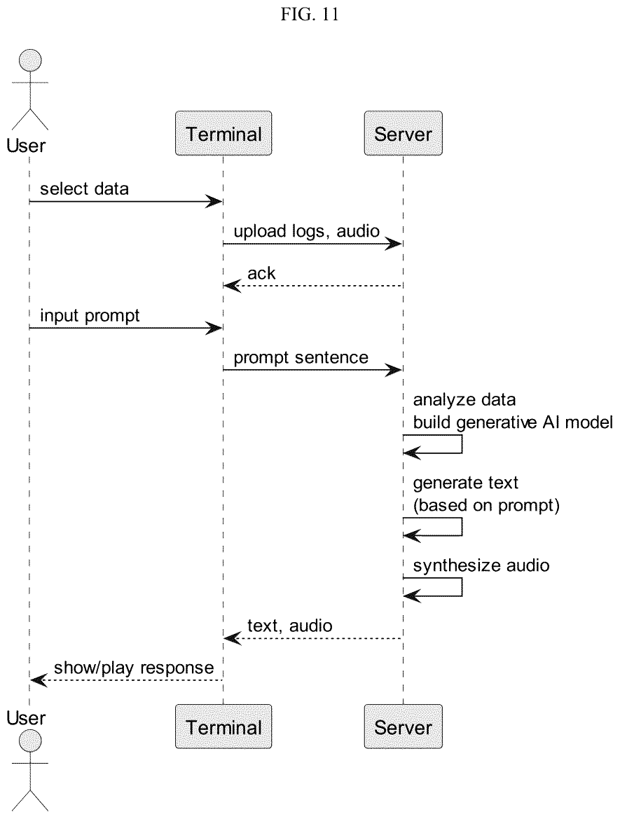

The following describes the processing flow using FIG. 11.
Step 1:

The user collects communication record data of a target speaker. The user selects, on the terminal, message logs and audio recordings stored in the terminal, such as text messages and call recordings. The input to this step is raw human-readable content (text conversations and audio files) stored in the terminal's file system or application storage. The output of this step is a selection list or set of file handles that the terminal can programmatically access for subsequent processing.

### Step 2:

The terminal reads the selected message logs and audio recordings. The terminal uses operating system file APIs and media APIs to open text files, database-backed message stores, and audio files. The input to this step is the selection list from Step 1. The terminal converts message records into an intermediate structured representation including a timestamp, a speaker identifier, and message content, and verifies audio formats and durations. The output of this step is an in-memory collection of structured text records and validated audio records.
Step 3:

The terminal normalizes and packages the communication record data. The terminal converts each text record into a unified schema, for example mapping application-specific fields to generic fields such as conversation ID, speaker ID, timestamp, and content. The terminal may compress long conversations and encode text in a standard character encoding. The input to this step is the in-memory collection of structured text records and audio records from Step 2. The terminal creates a data package, such as a set of structured files, that includes the normalized text records and references or binary contents of the audio files. The output of this step is a transmission-ready data package containing normalized communication history information and audio record information.

Step 4:

The terminal transmits the data package to the server. The terminal establishes a secure network session and sends the data package in one or more HTTP or similar requests. The input to this step is the data package from Step 3. The terminal may divide the package into chunks, add metadata headers (such as user ID and target speaker ID), and manage retries on network errors. The output of this step is a set of network messages delivered to the server that carry the communication record data.
Step 5:

The server receives and stores the communication record data. The server listens on a network interface, accepts incoming requests, and parses the payloads. The input to this step is the set of network messages sent from the terminal in Step 4. The server verifies integrity (for example, checksums, file size limits) and authentication tokens, and then writes the raw files to a storage device and registers metadata in a database. The output of this step is a persistent record of the uploaded communication history information and audio record information, referenced by internal identifiers.
Step 6:

The server normalizes communication history information into conversation-based and speaker-based structured data. The server loads the stored text logs, parses them using text parsing routines, and assigns each message to a conversation ID based on metadata or heuristic grouping. The input to this step is the raw or semi-structured text data stored in Step 5. The server sorts messages by timestamp, assigns speaker roles, and constructs conversation sequences in which each element includes conversation ID, speaker ID, timestamp, and message text. The output of this step is a set of conversation objects and speaker-indexed lists stored in memory or in a structured data store.
Step 7:

The server preprocesses audio record information and aligns it with text conversations. The server reads the audio files from storage and loads each file into memory using an audio processing library. The input to this step is the audio record information and conversation-based structured data from Step 6. The server resamples the audio to a common sampling rate, converts stereo to mono, and splits audio into segments using silence detection or timestamps. The server aligns each audio segment with a conversation segment based on time or annotation, and stores references to aligned pairs. The output of this step is a multi-modal dataset linking conversation units with corresponding audio segments.
Step 8:

The server executes natural language processing on the structured text data. The server tokenizes sentences, segments text into tokens, and applies part-of-speech tagging and sentence boundary detection using an NLP library. The input to this step is the conversation-based structured text data from Step 6. The server generates token sequences for each utterance, identifies sentence boundaries, and may compute additional annotations such as sentiment or politeness levels using trained classifiers. The output of this step is an enriched textual dataset in which each utterance is represented as a sequence of token IDs and associated annotations.
Step 9:

The server performs audio signal processing to extract acoustic features. The server computes numerical features such as spectral coefficients, pitch curves, energy envelopes, and temporal statistics for each aligned audio segment. The input to this step is the aligned audio segments from Step 7. The server uses signal processing algorithms to transform waveform samples into time-frequency representations and summary statistics. The output of this step is a set of acoustic feature vectors associated with each audio segment.
Step 10:

The server extracts speaker feature data by aggregating and modeling patterns from text and audio. The server aggregates token statistics to calculate lexical selection tendencies, analyzes sentence structures to derive recurring syntactic patterns, and examines response behavior to derive typical response lengths and context-response mappings. The input to this step is the enriched textual dataset from Step 8 and the acoustic feature vectors from Step 9. The server also aggregates acoustic features to compute typical pitch ranges, speaking rates, and spectral shapes. By applying statistical analysis and embedding models, the server produces high-dimensional representations of the target speaker's lexical, structural, response, and acoustic characteristics. The output of this step is unified speaker feature data stored as vectors, matrices, and distributions in memory or persistent storage.
Step 11:

The server constructs and fine-tunes a generative AI model conditioned on the speaker feature data. The server selects a pre-trained language generation architecture, initializes its parameters, and prepares training batches consisting of context token sequences and target token sequences from the conversation data. The input to this step is the structured conversation dataset and the speaker feature data from Step 10. The server feeds batches through the model, computes a loss function such as cross-entropy between predicted tokens and ground-truth tokens, and updates model weights via a gradient-based optimization algorithm. The server incorporates speaker feature embeddings into the model input or intermediate layers so that the model's outputs are biased toward the target speaker's style. The output of this step is a fine-tuned generative AI model with parameters adjusted to conform to the expression style of the target speaker.
Step 12:

The server prepares an audio synthesis pipeline for generating audio response signals. The server configures an acoustic model that maps token or phoneme sequences and speaker embeddings to acoustic feature sequences, and configures a waveform generation model that converts these features into time-domain waveforms. The input to this step is the acoustic feature vectors and speaker embeddings from Step 10 and, optionally, pre-trained acoustic and vocoder model parameters. The server trains or fine-tunes these models using loss functions measuring differences between generated and real spectrograms and waveforms. The output of this step is a pair of trained models stored in the server: an audio synthesis model and a waveform generation model specialized for the target speaker.
Step 13:

The user inputs a natural language prompt sentence through the terminal. The user enters text into a user interface element provided by the terminal. The input to this step is the user's natural language intention, which is captured as a text string. Example prompt sentences include “Please talk about today's weather as if you were sending a message to a close friend, in the same style as the deceased used.” and “Please write a short encouraging message about starting a new job, in the style of the deceased.” The output of this step is a digital text string available to the terminal application.
Step 14:

The terminal transmits the prompt sentence and optional generation conditions to the server. The terminal encapsulates the text string and parameters such as desired response length or style level into a request payload and sends it to the server over the network. The input to this step is the prompt sentence from Step 13 and any user-selected options. The terminal may add identifiers for the target speaker profile and conversation context. The output of this step is a network request delivered to the server containing a prompt sentence and generation conditions.
Step 15:

The server constructs a structured prompt sentence for the generative AI model. The server receives the request and parses the prompt text and parameters. The input to this step is the natural language prompt sentence and generation conditions from Step 14, and stored speaker feature data from Step 10. The server maps generation conditions to control tokens or embeddings (for example, tokens indicating short or long response, casual or formal style, and specific topic range), and prepends or appends these tokens to the tokenized prompt text. The output of this step is a token sequence representing a structured prompt sentence that encodes topic, situation information, style constraints, and target speaker style.
Step 16:

The server generates a text response sentence using the generative AI model. The server feeds the structured prompt token sequence into the fine-tuned generative AI model loaded in memory. The input to this step is the structured prompt from Step 15 and the model parameters from Step 11. The model executes its layers on the processor or hardware accelerator, computing attention over previous tokens and speaker feature embeddings, and outputs a probability distribution over next tokens at each step. The server applies a decoding algorithm (for example, top-k sampling) to select tokens iteratively until a termination condition is met. The output of this step is a generated token sequence, which the server converts back into a natural language text response sentence intended to imitate the target speaker's expression style.
Step 17:

The server generates an audio response signal corresponding to the text response sentence. The server converts the generated text into a sequence of input units (such as phonemes or characters) and feeds them, together with the target speaker embeddings, into the audio synthesis model. The input to this step is the text response sentence from Step 16 and the audio synthesis and waveform generation models from Step 12. The audio synthesis model produces an acoustic feature sequence, which is then passed to the waveform generation model to produce a time-domain waveform. The output of this step is a digital audio response signal representing synthesized speech in the target speaker's vocal style.
Step 18:

The server transmits the generated text response sentence and audio response signal to the terminal and records dialogue history information. The server packages the text and, when applicable, the audio data or a reference to stored audio, into a response message. The input to this step is the text response sentence from Step 16 and the audio response signal from Step 17. The server writes a new record in a dialogue history store that includes the original prompt sentence, the generated response, timestamps, and conversation identifiers. The server then sends the response message to the terminal over the network. The output of this step is a persisted dialogue history entry in the server and a network response carrying the generated text and audio.
Step 19:

The terminal presents the generated response to the user. The terminal receives the response message, extracts the text and any audio content, and updates the user interface. The input to this step is the response message from Step 18. The terminal displays the text in a conversation view and, if audio is present, either streams or downloads the audio and plays it using local audio hardware. The output of this step is the visual and auditory presentation of the imitated target speaker response to the user, completing one interaction cycle and providing a new context for potential subsequent prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems that attempt to recreate the speech of a deceased person typically rely on generic text-to-speech engines or simple playback of previously recorded audio segments. Such systems suffer from several technical limitations in the field of computer technology.

First, existing approaches do not jointly model linguistic style and acoustic characteristics in an integrated manner. Text-based systems may reproduce some lexical patterns, but they fail to capture prosody, timing, and voice quality specific to an individual speaker. Conversely, systems that clone voice timbre from limited audio data often ignore higher-level language patterns such as characteristic wording, sentence structure, and thinking style. As a result, the generated outputs lack coherence between language and audio, which degrades the fidelity and naturalness of the synthesized speech.

Second, conventional generative models are typically conditioned by manually crafted and static prompts that are not systematically derived from structured analysis of user-specific data. This leads to unstable control of generative behavior, inconsistent reproduction of personal style, and increased computational overhead due to repeated ad hoc tuning of prompts and model parameters. The system behavior depends heavily on manual configuration rather than on a robust, machine-derivable representation of user style.

Third, there is a technical deficiency in how user-specific data is processed and represented within the computing system. Raw message logs and call recordings are often stored and accessed in unstructured form, which hinders efficient feature extraction and reuse. Without a dedicated pipeline that converts heterogeneous text and audio data into unified feature representations (e.g., linguistic feature vectors and speaker embeddings), it is difficult to achieve scalable, low-latency generation of personalized outputs. This results in inefficient use of processing resources, increased memory access, and higher end-to-end latency in serving user requests.

Fourth, existing client-server architectures frequently treat the generative AI model as a black box and do not expose a structured mechanism for constructing prompt sentences based on a learned style model. Consequently, server-side control over the generative AI model is limited, making it challenging to produce consistent, high-quality responses that maintain the deceased person's characteristic style over time and across different use cases (such as diary reading, dialog, and commemorative messages).

Accordingly, there is a need for an improved computer-implemented technique that: (i) acquires and preprocesses both character information and audio information related to a deceased person, (ii) generates, within a server, explicit language style models and voice profiles, (iii) automatically constructs prompt sentences for a generative AI model based on these models, and (iv) synthesizes and delivers audio signals that consistently imitate both the linguistic and acoustic characteristics of the deceased person, thereby improving the technical performance, controllability, and efficiency of the generative system.

The specific processing by the specific processing unit 290 of the data processing device 12 in Application Example 1 is realized by the following means.

The present invention provides a server comprising a processor configured to acquire, from a storage device, character information and audio information related to a deceased person; to perform preprocessing on the character information by natural language processing to extract linguistic feature information for each utterance unit and to perform preprocessing on the audio information by signal processing to extract acoustic feature information for each utterance unit; to generate, based on the linguistic feature information, a language style model representing vocabulary, expressions, writing style, and thinking patterns characteristic of the deceased person and to generate, based on the acoustic feature information, a voice profile including a speaker embedding representing voice quality and prosody characteristic of the deceased person; to configure a generative AI model for generation processing based on the language style model and the voice profile such that the generative AI model imitates a tone, expressions, and thinking patterns of the deceased person; to generate a prompt sentence for the generative AI model, the prompt sentence specifying a conversation topic, a situation, and a narrative manner, based on input information from a user and the language style model; to input the prompt sentence and the input information into the generative AI model and to generate response character information that imitates the tone and expressions of the deceased person; to perform a speech synthesis process to generate a synthesized audio signal that imitates the voice quality and prosody of the deceased person based on the response character information and the voice profile; and to encode the synthesized audio signal into an audio data format capable of being delivered to a user terminal and to transmit the encoded audio data to the user terminal through a communication network. This enables the computing system to efficiently and consistently reproduce both linguistic and acoustic characteristics of the deceased person in a server-controlled manner, thereby improving the technical operation of generative AI-based speech synthesis, reducing latency and manual configuration, and enhancing controllability and fidelity of personalized audio generation in a client-server environment.

The term “processor” refers to a hardware or virtual computation unit, such as a central processing unit or a processing core in a computing device, that executes machine-readable instructions to perform data acquisition, analysis, model generation, and control operations described in the present invention.

The term “storage device” refers to any non-transitory computer-readable medium, such as a magnetic storage device, an optical storage device, a semiconductor memory, or a network-based storage service, that stores character information, audio information, models, profiles, and configuration data used by the processor.

The term “character information” refers to text-based data associated with a deceased person, including but not limited to message logs, diary entries, transcribed speech, and other symbolic representations of language that can be processed by natural language processing techniques.

The term “audio information” refers to digital audio data associated with a deceased person, including but not limited to recorded speech, call recordings, voice messages, and other sound data that can be processed by signal processing techniques.

The term “natural language processing” refers to a set of computational techniques executed by the processor for analyzing and transforming human language in text form, including operations such as tokenization, segmentation, syntactic analysis, semantic analysis, and feature extraction from character information.

The term “signal processing” refers to a set of computational techniques executed by the processor for analyzing and transforming audio signals, including operations such as filtering, noise reduction, segmentation, feature extraction, and format conversion applied to audio information.

The term “linguistic feature information” refers to structured data derived from character information, including but not limited to feature vectors, statistics, and labels that represent vocabulary usage, expressions, sentence patterns, and other language characteristics for each utterance unit.

The term “acoustic feature information” refers to structured data derived from audio information, including but not limited to spectral features, prosodic features, and temporal features that represent pitch, energy, timbre, and rhythm for each utterance unit.

The term “utterance unit” refers to a segment of text or audio corresponding to a meaningful spoken or written unit, such as a sentence, phrase, or short speech segment, that is used as a basis for extracting linguistic feature information and acoustic feature information.

The term “language style model” refers to a data structure or model parameter set generated by the processor that represents vocabulary, expressions, writing style, and thinking patterns characteristic of a deceased person and that is used to control or condition generative processing.

The term “voice profile” refers to a data structure generated by the processor that represents voice characteristics of a deceased person, including a speaker embedding, prosodic parameters, and other information used to control or condition speech synthesis.

The term “speaker embedding” refers to a numerical vector representation computed from audio information that encodes speaker-specific characteristics such as voice timbre and typical prosody in a form usable by a speech synthesis model.

The term “generative AI model” refers to a machine learning model, such as a neural network-based language model or multimodal model, that is configured by the processor to generate text or other outputs in response to input data and prompt sentences, and that can imitate stylistic characteristics of a deceased person.

The term “generation processing” refers to an operation in which the generative AI model produces response character information or other output data based on input information, a prompt sentence, and internal model parameters configured by the processor.

The term “prompt sentence” refers to a text instruction or sequence of text segments generated by the processor to control the behavior of the generative AI model, the text instruction specifying at least a conversation topic, a situation, and a narrative manner for generating response character information.

The term “input information” refers to data provided by a user to the server, including but not limited to user queries, text to be read aloud, selection of a mode of operation, and other parameters that influence the generation of response character information.

The term “response character information” refers to text data generated by the generative AI model under control of the processor, the text data imitating a tone and expressions of a deceased person and being suitable for conversion into synthesized speech.

The term “speech synthesis process” refers to a computational process executed by the processor or by a speech synthesis engine under control of the processor, in which response character information and the voice profile are converted into a synthesized audio signal representing speech.

The term “synthesized audio signal” refers to a digital audio waveform generated by the speech synthesis process that imitates voice quality and prosody of a deceased person according to the voice profile.

The term “audio data format” refers to an encoding format for digital audio, such as a compressed or uncompressed file format, that is suitable for storage, transmission, and decoding by a user terminal.

The term “communication network” refers to a wired or wireless data communication infrastructure, including local networks and wide area networks, through which audio data and control messages are transmitted between a server and a user terminal.

The term “user terminal” refers to an endpoint device operated by a user, such as a smartphone, tablet, wearable device, or other computing apparatus, that is configured to receive audio data from the server, decode the audio data, and output an audio signal.

The term “output device” refers to a hardware component of the user terminal, such as a loudspeaker, headphone interface, or bone conduction transducer, that converts decoded audio signals into sound perceivable by the user.

The term “conversation topic” refers to a subject matter or theme specified in the prompt sentence that constrains or guides the content of the response character information generated by the generative AI model.

The term “situation” refers to contextual information specified in the prompt sentence, including conditions such as time, place, relationship, or event context, that influences the style and content of the response character information.

The term “narrative manner” refers to a mode of expression specified in the prompt sentence, such as monologue, dialog, formal speech, or casual talk, that directs how the generative AI model structures and phrases the response character information.

The term “typical intonation” refers to prosodic patterns, such as pitch contours and emphasis tendencies, characteristic of a deceased person and derived from the language style model and the voice profile for inclusion in the prompt sentence or synthesis control.

The term “emotional tendencies” refers to characteristic emotional expressions and affective styles, such as optimism, calmness, or humor, associated with a deceased person and represented in the language style model.

The term “frequently used expressions” refers to words, phrases, or idioms that a deceased person tends to use repeatedly, identified by the processor from character information and included in the language style model and prompt sentence.

In one embodiment, a server cooperates with a terminal operated by a user to provide a system that recreates speech of a deceased person by integrating language style modeling, voice profiling, generative AI text generation, and neural speech synthesis. The system is implemented as a network-based client-server architecture in which the server executes most of the computationally intensive processing and the terminal mainly performs user interaction, data upload, and audio playback.

### A. Overall System Configuration

The server includes at least one processor, a main memory, a non-transitory storage device, and a network interface. The server runs an operating system such as a general-purpose server operating system, and an application stack including a web server, an application server, and a database management system. In one embodiment, the server uses a relational database engine and an object storage service to store character information, audio information, feature vectors, language style models, voice profiles, and synthesized audio.

The terminal includes at least one processor, a memory, a display, an input device (such as a touchscreen), an audio output device (such as a speaker or headphone interface), and a network interface. The terminal runs a mobile operating system or wearable operating system and executes an application program dedicated to the present invention. The terminal communicates with the server via a communication network such as the Internet, using secure communication protocols.

### B. Data Structures and Storage

The server stores character information and audio information related to a deceased person in structured forms. The server represents each piece of character information as a record including a text field, a timestamp, a source type (for example, message log, diary, email), and a conversation context identifier. The server represents each piece of audio information as an audio file accompanied by metadata including sampling rate, channel configuration, duration, timestamp, source type (for example, call recording, voice message), and a link to associated character information if available.

The server maintains a language style model for each deceased person as a data structure that includes: (i) a vocabulary distribution over subword or word tokens, (ii) a set of phrase templates and n-gram statistics, (iii) sentence length distributions, (iv) parameters representing politeness level, formality, and typical emotional tone, and (v) representative example expressions. These elements are represented by numerical parameters (for example, probability tables, real-valued vectors) and symbolic descriptors.

The server maintains a voice profile for each deceased person as a data structure that includes: (i) at least one speaker embedding vector (for example, a 256- or 512-dimensional real-valued vector), (ii) prosodic statistics such as average pitch, pitch variance, speaking rate, and pause distributions, and (iii) configuration parameters for a speech synthesis engine to reproduce typical emphasis and intonation patterns.

The server also maintains configuration data for a generative AI model. In one embodiment, the generative AI model is a transformer-based neural network, such as a multi-layer self-attention model trained for language generation. The server stores parameters that specify, for each deceased person, how to condition or bias the generative AI model with the language style model, for example by adjusting token sampling probabilities, adding style tokens, or modifying temperature and top-k parameters.

### C. Character Information Preprocessing and Language Feature Extraction

The server uses a natural language processing pipeline to process character information. The server executes software libraries such as a natural language processing framework to perform tokenization, sentence segmentation, part-of-speech tagging, and syntactic parsing. The server converts all text into a normalized form (for example, lowercasing, removing control characters, standardizing punctuation) and removes non-linguistic noise such as system-generated messages.

The server converts tokens or sentences into vector representations (embeddings) using a pretrained language representation model, such as a bidirectional encoder or a sentence encoder. The server represents each sentence or utterance unit as a fixed-dimensional embedding vector. The server then applies an unsupervised clustering algorithm, such as k-means clustering or hierarchical clustering, to group utterances into clusters that share similar vocabulary patterns and syntactic structures.

By clustering the embeddings, the server identifies recurring patterns that represent the deceased person's typical phrases, preferred sentence shapes, and characteristic expression patterns. The server computes, for each cluster, a centroid vector and cluster-level statistics (for example, distribution of sentence length, distribution of specific tokens). The server stores these statistics as part of the language style model.

This structured feature extraction and clustering provide a technical effect of improving the efficiency and accuracy of subsequent style conditioning. Instead of treating all text uniformly, the server organizes it into style-consistent groups, which allows the generative AI model to be conditioned more precisely, reducing variance in generated outputs and lowering the number of inference iterations needed to obtain a desired style.

### D. Audio Information Preprocessing and Acoustic Feature Extraction

The server processes audio information using signal processing techniques implemented in software libraries such as an audio processing toolkit and a multimedia framework. The server converts each audio file into a consistent internal format (for example, 16 kHz, mono, linear PCM). The server segments the audio stream into utterance units by detecting regions of silence using an energy-based or spectral-based voice activity detection algorithm. The server stores start and end timestamps for each utterance unit.

For each utterance unit, the server computes acoustic features such as Mel-frequency cepstral coefficients, log-mel spectrograms, pitch contours, energy contours, and voicing flags. The server may use sliding windows in the range of several tens of milliseconds and compute these features frame by frame. The server then aggregates these features to compute average pitch, pitch variance, typical pitch slope patterns, average speaking rate (for example, syllables per second), and pause statistics.

To generate a speaker embedding, the server passes the spectrograms or other features of each utterance through a speaker encoder neural network, which may be implemented as a stack of convolutional layers followed by recurrent layers and a fully connected layer. The encoder outputs a fixed-dimensional embedding vector for each utterance. The server aggregates these vectors across multiple utterances, for example by averaging or by using a robust aggregation method that down-weights outliers, to obtain a stable speaker embedding representing the deceased person's voice.

This transformation from raw waveforms into structured acoustic features and a speaker embedding enables the server to decouple speaker identity from content and to reuse the same embedding across many future synthesis requests. This reduces the need to access raw audio and perform heavy preprocessing each time, which improves processing speed and reduces memory and I/O load on the server.

### E. Construction of the Language Style Model and Voice Profile

The server generates the language style model by combining linguistic feature information from the text pipeline. The server calculates token frequency distributions, phrase co-occurrence statistics, and syntactic pattern frequencies per cluster. The server further derives style parameters such as politeness level by measuring the relative occurrence of specific lexical markers, and emotional tendencies by using sentiment analysis models that classify utterances into emotional categories.

The server parameterizes the language style model so that it can be directly applied to the generative AI model. For example, the server defines special style tokens that encode clusters or sentiment categories and maps the probability distributions of tokens in each cluster into bias vectors that can be added to the generative AI model's output logits during generation.

The server generates the voice profile by storing the speaker embedding and prosodic statistics, and by computing control parameters for the speech synthesis engine. For instance, the server sets default pitch scaling factors, speaking rate parameters, and pause insertion rules based on measured averages and variances. This configuration allows the speech synthesis engine to produce speech that reflects typical voice quality and rhythm of the deceased person, rather than generic speech.

This explicit modeling of style and voice at the server side improves technical performance by enabling the system to dynamically control the generative AI model and the speech synthesis engine using compact numerical parameters, rather than repeatedly analyzing raw data. This leads to reduced computational overhead, improved caching and reuse of style parameters, and more consistent generation quality.

### F. Configuration and Operation of the Generative AI Model

The server uses a generative AI model implemented as a transformer-based neural network. The model has multiple self-attention layers, feed-forward layers, and normalization layers. The server may use a pretrained model as a base and then adjust its behavior at inference time using the language style model, or optionally further fine-tune the model parameters on the deceased person's text.

The server configures the generative AI model by: (i) inserting style tokens that represent the deceased person's language style, (ii) adjusting the model's sampling temperature, top-k, or top-p parameters according to the desired level of creativity or adherence to learned patterns, and (iii) applying token-level bias vectors derived from the language style model to shift probabilities toward frequently used expressions and away from unlikely tokens.

The server generates a prompt sentence to instruct the generative AI model in a structured and repeatable manner. Examples of such prompt sentences include:
“You are simulating the deceased person's speaking style. The person typically speaks in a calm, reflective tone, often using short, simple sentences.
Rewrite the following diary entry as a spoken monologue in that style, suitable for text-to-speech synthesis. Do not add new facts, but you may slightly rephrase for natural spoken language:
[DIARY_TEXT].”
“Based on the deceased person's messenger history, you speak in a friendly, straightforward manner and occasionally make light jokes.
Generate a reply that this person might naturally say to the following message. Keep the reply under 80 words:
[USER_MESSAGE].”
“You are generating a short congratulatory message as if spoken by the deceased person, using their typical tone and vocabulary. The occasion is the user's birthday.
Create a warm, encouraging message that mentions the birthday and expresses hope for the future, in the deceased person's style:”

The server constructs such prompt sentences programmatically, using parameters and example phrases stored in the language style model, rather than relying on ad hoc manual creation. This automatic prompt construction reduces human intervention, increases consistency across requests, and enables the system to operate efficiently for multiple deceased persons with different styles.

### G. Speech Synthesis and Audio Delivery

The server performs a speech synthesis process by combining the response character information and the voice profile. In one embodiment, the server uses a sequence-to-sequence neural TTS model such as a model with an encoder-decoder architecture that converts text into a mel-spectrogram, followed by a neural vocoder such as a generative adversarial network-based vocoder that converts the spectrogram into a waveform.

The server conditions the TTS model with the speaker embedding and prosodic parameters contained in the voice profile. For example, the server concatenates the speaker embedding to encoder outputs or inputs it as a global conditioning vector, and adjusts pitch contours and speaking rate according to prosodic parameters. The server may also insert or lengthen pauses based on learned pause distributions, thus reflecting typical timing patterns of the deceased person.

The server obtains a synthesized audio signal in a linear PCM format and then uses signal processing software to normalize volume, remove unwanted leading and trailing silence, and encode the signal into a compressed audio data format such as a compressed file format suitable for streaming or download. The server stores the encoded audio on its storage and sends an address or stream to the terminal via the communication network.

The terminal receives the encoded audio data, decodes it using built-in codecs provided by the operating system, and outputs the corresponding audio signal through the output device. Because the server has precomputed a compact speaker embedding and style parameters, and uses them to efficiently guide the generative AI model and TTS engine, the time from user request to audible output can be reduced compared to systems that repeatedly analyze raw data or rely on manual tuning.

### H. Technical Effects and Improvement of Computer Technology

The server improves computer technology in several concrete ways. By transforming raw character information and audio information into structured feature representations (linguistic feature vectors, speaker embeddings, prosodic statistics), the server enables more efficient storage, retrieval, and computation. The compact representations reduce memory footprint and I/O bandwidth compared to repeatedly processing raw logs and recordings.

The server's clustering of linguistic feature vectors into style-consistent groups, and its derivation of token-level bias vectors, lead to more stable and targeted control of the generative AI model. This reduces the number of inference steps and post-processing corrections needed to generate outputs that match the desired style, thereby decreasing processor load and latency.

The server's use of a voice profile with a precomputed speaker embedding allows the TTS engine to operate without repeated speaker identification or adaptation on raw audio, improving throughput and enabling concurrent processing of multiple requests. The separation of style and content further allows reuse of the same embedded representation across multiple generations, which is not a mere automation of human work but a computational optimization that is unique to machine processing.

The server implements specific learning procedures for the neural networks used in the system. For example, the server may use supervised or self-supervised training for the speaker encoder, employing a loss function such as a triplet loss or a softmax cross-entropy over speaker identities to ensure that embeddings of the same speaker are close in the embedding space and embeddings of different speakers are distant. For fine-tuning of the generative AI model, the server may apply a cross-entropy loss between predicted tokens and ground-truth tokens of the deceased person's utterances during additional training epochs, and update model weights by gradient-based optimization methods. These operations result in a model that more accurately captures the deceased person's style, improving output fidelity and reducing error rates such as mismatched vocabulary or unnatural phrasing.

The server uses rule-based and non-conventional control logic on top of neural networks. For instance, the server may impose explicit constraints on maximum sentence length and enforce inclusion of certain frequently used expressions by post-processing generated token sequences according to rules stored in the language style model. The server may also use heuristic scoring functions that penalize outputs that deviate from learned style clusters. These approaches differ from typical human editing and from naive use of generative models, and are specifically tailored to machine-executed generation and control.

In sum, by defining specific data structures (language style model and voice profile), feature extraction pipelines, neural network architectures and training procedures, and automatic prompt sentence construction, the server implements a concrete technical solution that improves the functioning of computer-based generative systems. The system achieves improved generation accuracy, reduced response time, lower computational cost, and more efficient data management, thereby providing a technical improvement over conventional systems that merely automate human conversation or playback recordings without such structured processing.

### I. Variations and Alternative Embodiments

The server may adopt alternative algorithms for any of the described components. For example, the server may use different embedding models for linguistic feature extraction, such as character-level or subword-level encoders. The server may employ different clustering algorithms, such as density-based clustering, to handle large and diverse datasets. The server may also implement the generative AI model as a sequence-to-sequence model with explicit style embeddings instead of style tokens.

The server may implement the speech synthesis engine using different neural architectures, such as a transformer-based TTS system or an autoregressive vocoder, as long as the engine can accept the speaker embedding and prosodic parameters as conditioning signals. The server may further integrate an adaptive noise reduction module to improve robustness when the deceased person's audio information contains background noise.

The terminal may take various forms, including smartphones, tablet computers, desktop computers, or wearable head-mounted displays. In all cases, the terminal functions as a device that interacts with the server, uploads user-selected data, receives synthesized audio data, and outputs audio to the user through appropriate hardware.

By providing these concrete embodiments and variations, the present description enables a person skilled in the art to implement the invention using known hardware and software components while benefiting from the specific technical structures and operations that characterize the invention.

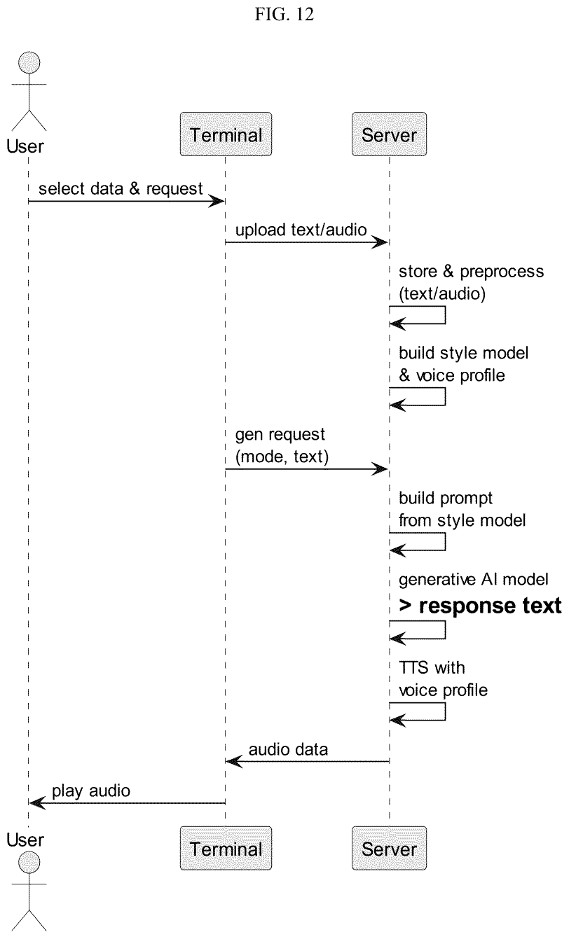

The following describes the processing flow using FIG. 12.
Step 1:

User operates the terminal to select source data related to a deceased person and to initiate processing.

User provides, as input, one or more items such as message logs, diary files, email texts, and audio recordings stored in the terminal or accessible cloud storage.

Terminal reads the selected files from local storage or from a remote storage service and generates a manifest including file paths, file types (text or audio), sizes, and timestamps.

Terminal outputs the selected data and the manifest as a request packet addressed to the server.
Step 2:

Terminal transmits the selected data and the manifest to the server through a communication network.

Terminal inputs the request packet and, using a network protocol, divides the data into one or more transmission units.

Terminal performs data packaging, such as compression and encryption, and sends the packaged data to an upload API endpoint on the server.

Terminal outputs a sequence of encrypted data packets that the server can reconstruct into the original files.
Step 3:

Server receives the data packets from the terminal and reconstructs the original files.

Server inputs the encrypted packets and applies decryption and decompression based on previously established session keys and formats.

Server assembles the packets into complete files, verifies integrity with checksums, and stores the files in a storage device, registering metadata such as user identifier, deceased-person identifier, file type, and upload time in a database.

Server outputs stored file records and associated metadata entries, which become the basis for later processing.
Step 4:

Server preprocesses character information to extract linguistic feature information.

Server inputs text-type files such as message logs, diary entries, and transcripts identified in the metadata as character information.

Server applies natural language processing, including normalization (character encoding unification and punctuation standardization), sentence segmentation, tokenization, and part-of-speech tagging.

Server then converts sentences into numerical vectors using a language embedding model and computes statistics such as token frequencies, sentence lengths, and common phrase patterns.

Server outputs structured linguistic feature information, comprising per-sentence embeddings, token statistics, and intermediate annotations linked to the original text records.
Step 5:

Server preprocesses audio information to extract acoustic feature information.

Server inputs audio-type files identified in the metadata as audio information associated with the deceased person.

Server performs signal processing, including resampling to a predetermined sampling rate, conversion to a uniform format, and segmentation into utterance units using voice activity detection.

Server calculates acoustic features for each utterance unit, such as Mel-frequency cepstral coefficients, pitch contours, and energy trajectories, by applying frame-based analysis over the waveform.

Server outputs acoustic feature information as numerical feature matrices and per-utterance feature summaries linked to timestamps and file identifiers.
Step 6:

Server generates a speaker embedding and constructs a voice profile for the deceased person.

Server inputs the acoustic feature information for multiple utterance units.

Server feeds feature sequences into a speaker encoder neural network, which applies several layers of convolution and aggregation to produce a fixed-dimensional embedding vector for each utterance.

Server aggregates these embedding vectors, for example by averaging and outlier filtering, to compute a stable speaker embedding representing the deceased person's voice characteristics.

Server combines the speaker embedding with prosodic statistics such as average pitch, speaking rate, and pause distributions to create a voice profile.

Server outputs a voice profile data structure stored in the database and referenced by the deceased-person identifier.
Step 7:

Server constructs a language style model for the deceased person.

Server inputs the linguistic feature information comprising sentence embeddings, token statistics, and phrase patterns.

Server applies a clustering algorithm to group sentences with similar embeddings into style clusters and calculates, for each cluster, distributions over tokens, average sentence lengths, and frequent expressions.

Server derives style parameters such as politeness level and emotional tendency by analyzing the prevalence of specific lexical markers and sentiment scores within clusters.

Server organizes these parameters into a language style model containing vocabulary distributions, cluster descriptors, example expressions, and control parameters for conditioning text generation.

Server outputs the language style model and stores it in association with the deceased-person identifier.
Step 8:

User operates the terminal to request generation of content in the deceased person's style.

User provides, as input, a usage mode (for example, diary reading, conversation, or commemorative message) and content such as new text to be read, a question to ask, or a brief topic description.

Terminal receives the user's selection and input, encapsulates them together with a reference to the deceased-person identifier, and prepares a generation request.

Terminal outputs the generation request as a structured message to be sent to the server.
Step 9:

Terminal transmits the generation request to the server.

Terminal inputs the user's mode selection, textual input, and identifiers, and uses an application protocol to format them into a request body.

Terminal sends this request to a generation API endpoint on the server via the communication network.

Terminal outputs the request in a form that the server can use to select relevant models and profiles.
Step 10:

Server constructs a prompt sentence for the generative AI model based on the language style model and the user's input.

Server inputs the generation request, the language style model, and associated style parameters and example expressions.

Server selects style descriptors such as tone (calm, humorous), typical sentence length, and frequently used expressions from the language style model and inserts them into a prompt sentence template corresponding to the selected usage mode.

By concatenating these descriptors with explicit instructions about the desired output format and the user's text or question, the server generates a concrete prompt sentence, for example:
“You are simulating the deceased person's speaking style. The person typically speaks in a calm, reflective tone, often using short, simple sentences.
Rewrite the following diary entry as a spoken monologue in that style, suitable for text-to-speech synthesis. Do not add new facts, but you may slightly rephrase for natural spoken language:
[DIARY_TEXT].”

Server outputs the constructed prompt sentence and the associated context to be used as input to the generative AI model.
Step 11:

Server generates response character information by controlling the generative AI model with the prompt sentence.

Server inputs the prompt sentence and any additional context text, such as the user's question or diary content, into the generative AI model configured with the deceased person's style parameters.

Server executes the generative AI model, which processes the tokenized prompt sentence and context through multiple transformer layers to produce probability distributions over output tokens, modified according to style biases derived from the language style model.

Server samples or decodes a token sequence from these distributions, constrained by style rules and maximum length, and then detokenizes the sequence into text that imitates the deceased person's tone and expressions.

Server outputs the resulting response character information as plain text associated with the request.
Step 12:

Server performs a speech synthesis process to convert the response character information and the voice profile into a synthesized audio signal.

Server inputs the response character information and the voice profile containing the speaker embedding and prosodic parameters.

Server uses a text-to-speech engine to convert the text into an intermediate representation, such as a mel-spectrogram, while conditioning the model with the speaker embedding and prosodic controls.

Server then passes the intermediate representation into a neural vocoder that generates a time-domain waveform, adjusting pitch and timing based on the prosodic parameters in the voice profile.

Server outputs a synthesized audio signal in an uncompressed or lightly compressed audio format.
Step 13:

Server encodes and prepares the synthesized audio signal for transmission to the terminal.

Server inputs the synthesized audio signal and target encoding parameters such as sampling rate, bit rate, and format type.

Server performs volume normalization, silence trimming, and encoding into a compressed audio format suitable for streaming or download, producing a file or byte stream.

Server registers the encoded audio in storage and generates a reference such as a file path or URL.

Server outputs a response message containing either the encoded audio data directly or a reference through which the terminal can obtain the audio.
Step 14:

Terminal receives the response from the server and obtains the encoded audio data.

Terminal inputs the server's response message, extracts either the audio data or its reference, and if necessary requests the audio file from the server using the provided reference.

Terminal stores the audio temporarily in local memory or buffer for playback.

Terminal outputs a ready-to-play audio buffer or file associated with the original user request.
Step 15:

Terminal decodes and plays back the synthesized audio for the user.

Terminal inputs the encoded audio data and uses platform audio codecs and playback APIs to decode the compressed stream into raw audio samples.

Terminal sends the decoded audio samples to the output device, such as a speaker or headphones, and may optionally display the response character information as on-screen text synchronously with the audio.

Terminal outputs sound that recreates the deceased person's voice and speaking style, enabling the user to perceive the generated content in audio form.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented dialogue systems that attempt to reproduce a deceased person's way of speaking generally rely on simple template matching or shallow style transfer applied to text-only data. Such systems typically ignore detailed speaker-specific acoustic features and long-term language usage patterns, and therefore cannot generate responses that are both linguistically consistent with the deceased person's characteristic expressions and acoustically consistent with the deceased person's voice quality. Moreover, existing architectures often treat text generation and voice synthesis as independent subsystems, without a unified feature representation that ties the deceased person's language features and speaker features together at the time of inference. As a result, these systems suffer from low naturalness, perceptible mismatch between the generated text and the synthesized voice, and significant latency and processing inefficiency when attempting real-time interaction.

In addition, conventional systems frequently fail to utilize generative AI models in a manner that is optimized for this specific task. For example, they may accept free-form user input and directly pass it to a generative model without constructing a structured prompt sentence that encodes conversation topic, context, and the deceased person's learned stylistic constraints. This lack of structured conditioning leads to unstable output quality, reduced controllability from the user's perspective, and increased computational overhead due to repeated trial-and-error prompts. Furthermore, voice synthesis components are often invoked with generic speaker parameters or pre-set synthetic voices, which do not leverage speaker embeddings derived from actual historical audio of the deceased person, thereby limiting personalization and emotional fidelity.

From a computer technology standpoint, there is a need for an improved processing architecture that (i) systematically acquires and integrates heterogeneous historical data (audio information and character information), (ii) extracts and maintains unified feature information that represents both speaker features and language features of a specific individual, (iii) constructs and drives a generative AI model using structured prompt sentences generated from user input, and (iv) feeds the generative model output, together with speaker embedding information, into a voice synthesis processing unit to generate an audio signal imitating the voice quality of the individual, all in a manner that supports low-latency transmission and playback on a user terminal. Such an architecture should improve the efficiency, consistency, and technical performance of the underlying computing system, including memory access patterns, model invocation control, and real-time audio generation and streaming, rather than merely providing a new presentation of information.

The specific processing by the specific processing unit 290 of the data processing device 12 in Example 2 is realized by the following means.

The present invention provides a server comprising a processor and one or more storage devices storing instructions that, when executed by the processor, cause the processor to acquire, from an information storage device that stores history information related to a deceased person, audio information and character information related to the deceased person; to perform feature extraction processing on the audio information and the character information to generate feature information representing speaker features and language features of the deceased person; to construct, on the basis of the feature information, a generative learning model configured to imitate a speech manner, an expression pattern, and a thought pattern of the deceased person; to generate, on the basis of input information acquired from a user, a structured prompt sentence for instructing the generative learning model regarding content of a response text, a conversation topic, and a conversation situation; to input the prompt sentence into the generative learning model to cause the generative learning model to output the response text reflecting the speech manner, the expression pattern, and the thought pattern of the deceased person; to acquire speaker embedding information on the basis of the speaker features included in the feature information; to input the response text and the speaker embedding information into a voice synthesis processing unit to generate an audio signal imitating a voice quality of the deceased person; to encode the audio signal as audio data; and to transmit the audio data to a user terminal via a communication path for decoding and reproduction. This enables a computer system to more efficiently and accurately reproduce individual-specific conversational behavior and voice characteristics by tightly coupling generative AI-based text generation with speaker-embedding-based voice synthesis, thereby improving technical performance in terms of data processing efficiency, model control, response consistency, and real-time audio delivery in comparison with conventional architectures.

The term “information storage device” refers to a hardware or virtual storage resource, such as a memory device or storage subsystem, that stores digital data including history information related to a deceased person, such as audio information and character information.

The term “history information related to a deceased person” refers to accumulated digital records associated with a specific individual, including but not limited to past communications, messages, or recordings, from which that individual's behavioral, linguistic, and acoustic patterns can be inferred.

The term “audio information” refers to digital data representing sound, including recorded speech of a deceased person, stored in a form suitable for processing by an information processing apparatus, such as sampled waveforms or encoded audio files.

The term “character information” refers to digital text data associated with a deceased person, including written messages, transcripts, or other textual content, represented as sequences of characters or tokens.

The term “feature extraction processing” refers to computational operations performed on input data, such as audio information and character information, to derive numerical or symbolic representations that capture salient properties of the data for subsequent machine processing.

The term “feature information” refers to data produced by feature extraction processing that encodes properties of a deceased person's speech and language, including speaker features and language features, in a format suitable for use by learning models and synthesis modules.

The term “speaker features” refers to characteristics of a person's voice, such as pitch, timbre, speaking rate, and prosodic profile, represented in a numerical or structured form derived from audio information.

The term “language features” refers to characteristics of a person's language use, such as vocabulary, grammatical tendencies, idiomatic expressions, and discourse patterns, represented in a numerical or structured form derived from character information.

The term “generative learning model” refers to a trained computational model that receives input data, such as a prompt sentence and feature information, and generates new output data, such as a response text, that statistically imitates patterns found in its training or conditioning data.

The term “generative artificial intelligence model” refers to a type of generative learning model implemented using artificial intelligence techniques, such as machine learning or deep learning, that is configured to produce human-like language or other content in response to input prompts.

The term “speech manner” refers to a characteristic style in which a person speaks, including habitual phrasing, rhythm, and formality level, as reflected in both lexical choice and syntactic patterns.

The term “expression pattern” refers to recurrent ways in which a person formulates statements, questions, or emotional expressions, including preferred phrases, stylistic markers, and rhetorical constructions.

The term “thought pattern” refers to a characteristic way in which a person tends to organize, prioritize, and relate ideas in communication, as inferred from repeated structures and content in their historical data.

The term “input information acquired from a user” refers to data provided by a user to the system, including natural language queries, commands, or other interaction signals, which are used as a basis for constructing a prompt sentence or controlling model behavior.

The term “prompt sentence” refers to a structured textual input prepared for a generative learning model, which encodes instructions, constraints, and contextual information regarding the desired content, style, and situation of a generated response.

The term “response text” refers to a textual output produced by a generative learning model in response to a prompt sentence, the content and style of which are configured to imitate the speech manner, expression pattern, and thought pattern of a deceased person.

The term “speaker embedding information” refers to a numerical representation, typically a vector or set of vectors, that encodes speaker features of a person's voice in a compact form suitable for conditioning a voice synthesis process.

The term “voice synthesis processing unit” refers to a hardware and/or software component configured to receive input text and speaker-related information, and to generate an audio signal representing synthesized speech corresponding to the input.

The term “audio signal” refers to a time-varying digital representation of sound, such as a sequence of sampled amplitude values, that can be converted to an analog signal for auditory reproduction.

The term “audio data” refers to digital data encoding an audio signal, possibly compressed or formatted according to a specific encoding scheme, for storage, transmission, or processing.

The term “communication path” refers to a logical or physical connection, such as a wired or wireless network link, through which digital data is transmitted between a server and a user terminal.

The term “user terminal” refers to an electronic device operated by a user, such as a personal computer, smartphone, or tablet, that is capable of receiving, decoding, and reproducing audio data provided by the system.

The term “acoustic output device” refers to a component or assembly, such as a loudspeaker or headphone, which converts an audio signal into sound waves perceptible by a human listener.

In the following embodiments, a server executes core data processing, a terminal performs user interaction and audio playback, and a user operates the terminal to initiate and control the overall flow. The same reference concepts may be implemented by various hardware and software configurations without departing from the scope of the claims.

### A. System Configuration

A server includes at least one processor (for example, a multi-core central processing unit and optionally a graphics processing unit), a main memory, a non-volatile storage device, and a network interface. The server operates under control of an operating system such as a general-purpose server operating system. The server executes an application program comprising multiple software modules, including a data acquisition module, a feature extraction module, a generative AI model control module, a prompt generation module, a voice synthesis interface module, and a streaming/output module.

A terminal includes a processor, a memory, a display, an input device such as a touch panel or keyboard, a network interface, and an acoustic output device such as a loudspeaker or headphone interface. The terminal operates under control of an operating system such as a mobile operating system or a desktop operating system and executes a client application or web browser.

A user operates the terminal to input text, receive audio data from the server, and listen to reproduced audio signals. The user is not required to perform any manual editing of voice signals or manual tuning of acoustic parameters.

### B. Data Acquisition and Storage

The server accesses an information storage device that stores history information related to a deceased person. The server uses a database management system, for example a relational database or a key-value store, to store and retrieve metadata, and uses an object storage system to store large binary objects such as audio recordings.

The server stores audio information as digital audio files, such as linear pulse-code-modulated waveforms or compressed audio formats, and stores character information as text documents, including message logs, transcripts of conversations, and other writings of the deceased person. The server associates each stored record with an identifier of the deceased person and with timestamps and context metadata.

The server thereby maintains a structured data repository in which audio information and character information are linkable via person identifiers and contextual attributes. This data structure enables the server to systematically select representative segments for feature extraction and model conditioning, improving data management and facilitating efficient access patterns.

### C. Feature Extraction for Language and Speaker Characteristics

The server executes a feature extraction module that includes separate pipelines for audio information and character information.

The server processes audio information by performing digital signal processing and neural feature extraction. The server divides each audio recording into frames, computes spectral representations such as Mel-frequency spectra, and normalizes amplitude and timing information. The server then inputs frame-level features into a speaker encoder network implemented as a deep neural network, such as a convolutional neural network combined with a recurrent or attention layer. The server configures this network to output a fixed-dimensional speaker embedding vector that captures speaker features such as timbre, typical pitch range, and average speaking rate.

The server aggregates speaker embedding vectors over multiple recordings of the same deceased person to compute a representative embedding, for example by averaging and then normalizing the vectors. The server stores this aggregated speaker embedding as speaker embedding information in the database, thereby enabling reuse during multiple future synthesis operations without recomputing the full audio feature pipeline. This reduces computational load and latency, improving overall processing efficiency.

The server processes character information using a natural language processing pipeline. The server tokenizes text, normalizes linguistic variants, and extracts language features via a language encoder, such as a transformer-based encoder network. The server determines distributions over word usage, syntactic constructions, and discourse patterns and compresses these distributions into a set of numerical vectors that represent language features of the deceased person.

The server stores language features in association with the deceased person identifier. The server may also store representative text segments that exhibit characteristic expressions and thought patterns. This structure allows the server to condition a generative AI model on both aggregate statistics and concrete examples.

### D. Construction and Control of the Generative AI Model

The server constructs a generative learning model configured to imitate a speech manner, an expression pattern, and a thought pattern of the deceased person. In one embodiment, the server fine-tunes a base generative AI model, such as a transformer-based language model, using text data drawn from the character information. The server uses supervised learning on pairs of input-output sequences where context segments and the deceased person's actual utterances are used as training examples.

The server configures the model with specific architectural parameters, including number of layers, attention heads, hidden dimensions, and positional encoding scheme. The server uses a loss function such as cross-entropy over predicted tokens, and updates network weights using an optimization algorithm such as stochastic gradient descent with adaptive moment estimation. The server applies techniques such as learning-rate scheduling, gradient clipping, and regularization to stabilize training.

The server may use data augmentation procedures specific to this task. For example, the server may generate alternative phrasings preserving the deceased person's style by substituting synonyms observed in the historical data, or may shuffle independent clauses while preserving discourse markers. These non-standard, task-specific augmentation rules provide more varied but style-consistent training samples, which improves generalization of the generative AI model and reduces overfitting to particular phrases.

The server stores the trained generative AI model as part of the application program and loads it into memory for inference. During operation, the server does not require human intervention to specify detailed stylistic controls at each inference; instead, the server encodes such controls in structured prompt sentences and uses internal attention mechanisms and learned embeddings to enforce style consistency.

This architecture is distinct from manual script editing, because the server learns a multi-dimensional representation of linguistic behavior and uses it algorithmically to generate new outputs. The server thus improves the technical performance of text generation by reducing manual rule specification and by enabling rapid, consistent inference on computational hardware.

### E. Prompt Sentence Generation and Conditioning

The server receives user-provided input information via the terminal and constructs a prompt sentence that encodes conversation topic, situation, and desired stylistic constraints. The server uses a prompt generation module that parses user input, extracts key entities and intent, and then composes a structured textual instruction that both the generative AI model and the subsequent voice synthesis pipeline can interpret consistently.

For example, the user may input one of the following prompt sentences directly at the terminal:
“Please generate audio of the deceased person saying ‘Good morning’ in their usual tone.”
“Please generate audio of the deceased person saying ‘Good morning, how are you feeling today?’ in a more cheerful tone.”
“Please generate audio of the deceased person saying ‘Good morning. Don't push yourself too hard today.’in a calm and gentle voice.”

In another embodiment, the user may input a higher-level instruction directed to the generative AI model such as:
“As a generative AI model conditioned on the deceased person's writings and recordings, please produce the exact sentence to be spoken and then synthesize it in the deceased person's voice: ‘Good morning. I'm always watching over you, so do your best today.’”

The server converts these inputs into internal prompt sentences that include explicit markers for persona, emotional tone, and contextual metadata. Because the server uses explicit fields and tags within the prompt sentence, the generative AI model can systematically adjust lexical choices, sentence length, and discourse structure, reducing ambiguity and improving consistency of outputs. This structured approach goes beyond simply forwarding user text and constitutes a technical mechanism for model control and reproducible inference behavior.

### F. Response Text Generation Under Unified Feature Control

The server inputs the structured prompt sentence and the language features of the deceased person into the generative AI model. Internally, the server concatenates embeddings of prompt tokens with learned style embeddings derived from the language features. The server sets decoding parameters, such as temperature, top-k or top-p sampling thresholds, and maximum output length, based on system policies and user-specified constraints.

The server performs forward passes through the generative AI model on its processor and, when available, on a graphics processing unit optimized for matrix operations. The server thereby generates a response text that imitates the deceased person's manner of speaking, including typical expressions, polite level, and preferred rhetorical patterns. The server may apply post-processing rules to enforce constraints such as maximum number of sentences or avoidance of specific undesired terms.

By integrating style embeddings directly into the decoding process rather than only at training time, the server can rapidly adapt the output distribution for each deceased person without re-training the entire model. This improves computational efficiency and allows many users to share a base model while each deceased person's style is available as a lightweight configuration.

### G. Voice Synthesis Using Speaker Embedding Information

The server uses the response text and the previously computed speaker embedding information to generate an audio signal. The server operates a voice synthesis processing unit, which may be implemented as a neural text-to-speech engine with a sequence-to-sequence acoustic model and a neural vocoder.

The server converts the response text into phonetic or linguistic features using a front-end module. The server then combines these features with the speaker embedding vector and inputs them into an acoustic model such as a recurrent or transformer-based network that outputs intermediate acoustic features like Mel-spectrogram frames. The server inputs the intermediate representation and the speaker embedding into a vocoder network, such as a generative adversarial network or an autoregressive waveform generator, to produce a time-domain audio signal.

The server thereby exploits a non-trivial mapping between text, speaker embedding, and waveform space that cannot be performed by simple concatenation of prerecorded segments. The server's use of an embedding-conditioned neural architecture permits continuous interpolation between speaker characteristics and precise adaptation to the deceased person's voice, which improves accuracy and naturalness compared to generic synthetic voices.

### H. Encoding, Transmission, and Playback

The server encodes the generated audio signal into audio data that is suitable for transmission. The server may use encoding formats that balance quality and bandwidth, such as linear PCM for high-fidelity local storage and compressed formats for network streaming. The server also segments audio into blocks for real-time streaming, reducing initial latency before playback begins on the terminal.

The server transmits audio data to the terminal via a communication path, using a transport protocol with buffering and error-handling mechanisms. By streaming smaller segments rather than waiting for complete file generation, the server reduces perceived response time and optimizes use of network resources.

The terminal receives the audio data, decodes it using the operating system's multimedia framework, and outputs an audio signal to the acoustic output device. The terminal may handle buffer management, resampling, and volume control. The user hears the deceased person's reconstructed voice, with both linguistic content and acoustic characteristics determined by the internal processing of the server.

### I. Technical Effects and Computer-Technology Improvements

The server improves computer technology in several concrete ways. First, the server introduces a unified feature representation that binds together language features and speaker features of a specific individual. This representation allows the server to avoid redundant computation and lookup operations; the server can reuse stored embeddings and style vectors rather than repeatedly computing them from raw data, thereby improving processing speed and reducing energy consumption.

Second, the server's structured prompt generation and model conditioning procedure enhances stability and controllability of generative inference. Rather than relying on ad hoc user prompts, the server enforces a formal structure and explicit fields for persona and emotional tone. This reduces the number of required inference iterations and mitigates unstable outputs, leading to lower computational load and shorter end-to-end latency.

Third, the server's architecture for integrating generative text output with embedding-conditioned neural voice synthesis constitutes a non-conventional data flow that avoids the mismatch found in systems that treat text generation and voice synthesis as independent modules. By using a common set of feature information across both components, the server achieves tighter alignment between style and voice, reducing error rates in perceived identity and increasing accuracy of the reproduced persona.

Fourth, the server uses specialized learning and inference algorithms, including transformer-based language encoders, speaker encoder networks, and neural vocoders, with explicit control of loss functions, optimization strategies, and decoding parameters. These algorithmic choices, together with the task-specific data augmentation and embedding integration strategies, result in higher quality outputs and more efficient use of computational resources compared to conventional rule-based or shallow learning approaches.

These improvements go beyond merely automating what a human could do manually. A human operator cannot feasibly compute high-dimensional embeddings, solve large-scale optimization problems over network weights, or real-time synthesize waveforms conditioned on style vectors. The server performs such operations at machine speed and scale, resulting in a genuine improvement to the underlying computer system's capability to process, store, and transmit complex multimodal data.

### J. Variations and Alternative Embodiments

The server may implement different neural architectures for the generative AI model, including encoder-decoder transformers, decoder-only transformers, or hybrid recurrent-attention models. The server may also vary the dimension and structure of speaker embeddings, for example using a single global vector or a set of vectors corresponding to different speaking conditions.

The server may employ alternative optimization algorithms, such as second-order methods or adaptive gradient algorithms, and may modify the loss function to include auxiliary terms for style consistency or prosody control. The server may also adjust decoding algorithms, using beam search, nucleus sampling, or constrained decoding, to achieve different trade-offs between diversity and determinism.

The terminal may be implemented as a dedicated appliance or integrated into another electronic device, and the acoustic output device may be a speaker array or a wearable device. The communication path may include various network topologies and protocols, and the server may distribute processing across multiple nodes for scalability.

The user may provide different types of prompt sentences, either specifying exact phrases or delegating phrase creation to the generative AI model, and the server may expose configuration options to adjust emotional tone, speaking speed, and other parameters. In all such variations, the essential operations of acquiring history information, extracting feature information, constructing and controlling a generative learning model, producing response text, generating an audio signal using speaker embedding information, and transmitting audio data to a terminal remain within the scope of the claims.

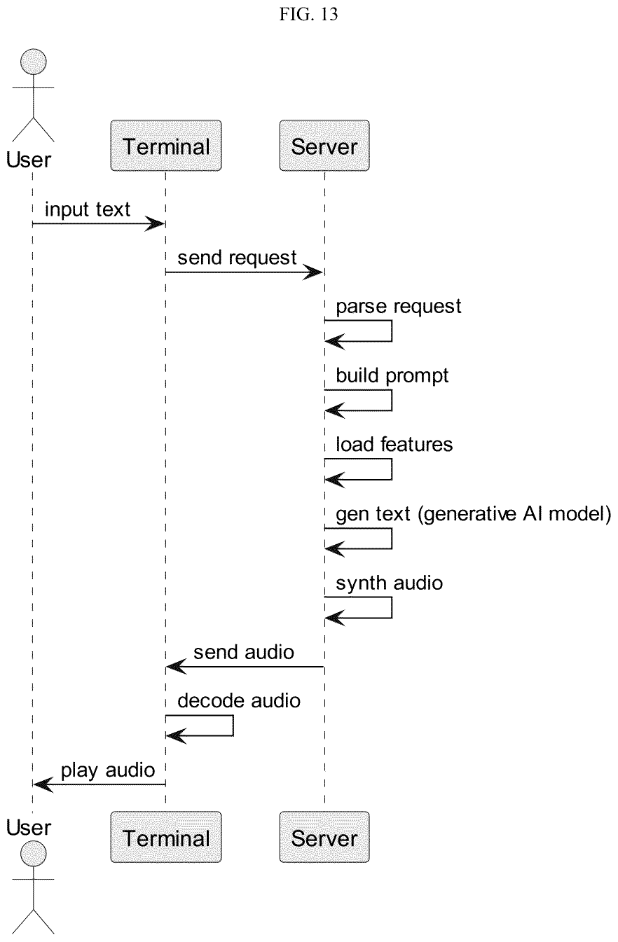

The following describes the processing flow using FIG. 13.
Step 1:

The user operates the terminal to input an initial instruction. The user views a text input field on the terminal display and types a natural-language request such as: “Please generate audio of the deceased person saying ‘Good morning’ in their usual tone.” The user then activates a send or generate control on the terminal.

Input: A natural-language instruction text entered by the user.

Output: A request message containing the instruction text, prepared for transmission to the server.

The terminal converts the instruction text into a data structure (for example, a JSON object in memory) that includes at least a user identifier and the raw text string. The terminal then passes this data structure to its communication module for network transmission.
Step 2:

The terminal sends the user instruction to the server. The terminal uses a network interface and an operating system networking stack to encapsulate the request in a network protocol (for example, HTTP over TCP/IP).

Input: The request message containing the user instruction text and associated metadata.

Output: A network packet stream transmitted to the server.

The terminal opens a secure connection to the server, serializes the request message into a byte stream, and transmits the bytes over the communication path. The terminal then waits for a response from the server.
Step 3:

The server receives and parses the user instruction. The server's network interface delivers the incoming packets to a server application, which reconstructs the original request message.

Input: The network packet stream containing the request message from the terminal.

Output: A parsed instruction object stored in server memory, including the raw instruction text and user identifier.

The server decodes the byte stream according to the communication protocol, verifies integrity and authentication, and extracts the instruction text. The server then stores the text in a structured object (for example, a record containing fields for requested phrase, emotional tone, and context, initially unfilled).
Step 4:

The server analyzes the instruction to extract semantic elements needed for a prompt sentence.

Input: The parsed instruction object with the user's natural-language text.

Output: A set of extracted elements including desired phrase content, stylistic parameters, and conversation context.

The server applies a natural language processing routine that tokenizes the text, identifies quoted content (for example, “Good morning”), detects modifiers indicating tone (for example, “usual tone,” “cheerful,” “calm”), and identifies whether the user is requesting a fixed phrase or allowing the system to construct the phrase. The server writes these elements into the structured object, filling fields such as “target_utterance,” “emotion_tag,” and “persona_flag.”
Step 5:

The server retrieves history information of the deceased person from storage.

Input: The user identifier and deceased-person identifier associated with the instruction.

Output: A set of data records containing audio information and character information related to the deceased person.

The server queries a database using the deceased-person identifier to obtain file references for stored recordings and text documents. The server loads metadata and, if necessary, representative samples of audio and text into memory. The server thereby prepares raw data from which feature information will be computed or retrieved.
Step 6:

The server derives or loads feature information representing language features and speaker features of the deceased person.

Input: Audio information and character information stored for the deceased person, and any previously computed feature information.

Output: A feature information object comprising language feature vectors and speaker embedding information.

If precomputed features are available, the server loads language feature vectors and speaker embedding vectors directly from a feature database. If precomputed features are not available, the server executes a feature extraction pipeline: it processes audio frames to compute acoustic descriptors and passes them through a speaker encoder neural network to obtain a speaker embedding; it processes text tokens through a language encoder network to obtain language feature vectors. The server aggregates and normalizes these vectors and stores the result as feature information, which it also persists for reuse.
Step 7:

The server generates a structured prompt sentence for a generative AI model.

Input: The extracted semantic elements from the user instruction and the language features of the deceased person.

Output: A structured prompt sentence encoded as text, including explicit style and context tags.

The server composes a prompt string that may, for example, indicate: (i) that the model should speak as the deceased person, (ii) the desired emotional tone, and (iii) the conversation topic. The server may embed control tokens or markers, such as “[PERSONA=DECEASED]”, “[TONE=USUAL]”, and “[CONTENT=‘Good morning’]”. The server concatenates these markers with brief representative text phrases extracted from the deceased person's writings to bias the style. The resulting prompt sentence is stored in memory as a string to be supplied to the generative AI model.
Step 8:

The server generates a response text by using the generative AI model conditioned on the prompt sentence and language features.

Input: The structured prompt sentence and the language feature vectors representing the deceased person's style.

Output: A response text imitating the deceased person's speech manner, expression pattern, and thought pattern.

The server embeds the prompt sentence tokens and combines them with style embeddings derived from the language feature vectors. The server feeds these embeddings into a generative AI model, implemented for example as a transformer-based neural network, and executes forward passes layer by layer. During decoding, the server applies sampling or beam search algorithms to select output tokens according to probability distributions produced by the model's output layer. The resulting token sequence is detokenized into a natural-language response text, which the server stores in memory.
Step 9:

The server prepares the response text and speaker embedding information for voice synthesis.

Input: The response text generated by the generative AI model and the speaker embedding vectors computed for the deceased person.

Output: A synthesis request object containing response text, speaker embedding, and prosody parameters.

The server assigns prosody parameters such as base speaking rate and pitch adjustments, possibly derived from the speaker features and requested emotional tone. The server then constructs a data structure that includes the text string, the speaker embedding vector, and synthesis options. This object is passed to the voice synthesis processing unit.
Step 10:

The server generates an intermediate acoustic representation from the response text and speaker embedding.

Input: The synthesis request object including text, speaker embedding, and prosody parameters.

Output: A sequence of acoustic feature frames, such as Mel-spectrogram frames, aligned with the response text.

The server first applies a text front-end that converts the response text into phonemes or grapheme sequences and adds timing and stress markers. The server feeds these sequences and the speaker embedding into an acoustic model network (for example, a sequence-to-sequence neural network with attention). The acoustic model computes, for each time step, a vector of spectral features. The server collects these feature vectors into an ordered list representing the full utterance, which is stored in memory as the intermediate representation.
Step 11:

The server converts the intermediate acoustic representation into a time-domain audio signal.

Input: The sequence of acoustic feature frames and the speaker embedding information.

Output: A digital audio signal representing synthesized speech in the deceased person's voice.

The server inputs the acoustic feature sequence and speaker embedding into a vocoder network, such as a neural waveform generator. The vocoder performs a series of convolutional or autoregressive operations to predict waveform samples for each frame. The server concatenates the predicted samples into a continuous digital audio signal at a defined sampling rate. The server may perform normalization, noise shaping, or post-filtering on the waveform to ensure smooth playback quality.
Step 12:

The server encodes and segments the audio signal for transmission to the terminal.

Input: The digital audio signal representing the synthesized utterance.

Output: Encoded audio data segments suitable for network transmission.

The server selects an encoding format (for example, linear PCM or a compressed codec) and converts the raw waveform into encoded frames. The server may divide the encoded data into smaller chunks to enable streaming playback. The server then wraps these chunks into response messages with headers describing format, length, and sequence, and passes them to the network interface.
Step 13:

The server transmits the encoded audio data to the terminal.

Input: The encoded audio data segments and associated metadata.

Output: A network packet stream carrying audio data from the server to the terminal.

The server uses a transport protocol to send the audio data segments over the communication path. The server may manage buffering and retransmission policies to maintain continuous delivery. When sufficient initial data has been sent, the server continues to stream remaining segments until the entire audio signal has been transmitted.
Step 14:

The terminal receives and buffers the encoded audio data.

Input: The network packet stream sent by the server.

Output: A buffered set of encoded audio data segments stored in terminal memory.

The terminal's network stack reconstructs the segments from incoming packets and verifies their order and integrity. The terminal places the encoded data into a playback buffer, tracking segment indices and timestamps. The terminal then notifies a media playback module that data is available for decoding.
Step 15:

The terminal decodes the encoded audio data into an audio signal.

Input: The buffered encoded audio data segments.

Output: A decoded digital audio signal ready for playback.

The terminal applies an appropriate decoder according to the encoding format specified in the headers. The decoder converts each encoded segment into raw waveform samples and writes these samples into an output buffer. The terminal may handle sample-rate conversion and channel mixing, if required, to match the capabilities of the acoustic output device.
Step 16:

The terminal outputs the audio signal to the user via the acoustic output device.

Input: The decoded digital audio signal stored in the playback buffer.

Output: An analog sound wave perceived by the user as the deceased person's voice.

The terminal sends the digital samples to a digital-to-analog converter and then to the speaker or headphone circuitry. The terminal controls volume and timing to ensure smooth playback. The user hears the reconstructed voice of the deceased person, with linguistic content determined by the generative AI model and acoustic characteristics determined by the speaker embedding.
Step 17:

The user optionally refines the interaction by issuing additional instructions.

Input: The user's perception and evaluation of the reproduced voice and content.

Output: One or more new instruction texts entered at the terminal for subsequent processing.

After listening, the user may decide to request a different phrase or emotional tone, for example by entering: “Please generate audio of the deceased person saying ‘Good morning, how are you feeling today?’ in a more cheerful tone.” The user again operates the send control, causing the terminal to repeat Steps 1 and 2 and the server to repeat its processing from Step 3 onward, thereby creating an iterative interaction loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems that attempt to recreate speech or conversation of a deceased person primarily focus on content imitation at the text level or on static voice cloning. These systems typically (i) perform a one-time analysis of message logs, (ii) use a generic language model with minimal conditioning, and (iii) generate audio using a fixed speech synthesis profile. As a result, they suffer from several technical drawbacks: the generated responses often lack consistent linguistic characteristics of the specific deceased person across turns; prompt design is ad hoc and not systematically tied to the learned linguistic profile; session context and user state are not structurally incorporated; and synthesized audio is not dynamically adapted to the user's emotional state. From a computer-technology perspective, this leads to inefficient use of generative models, poor control over response style, and fragmented handling of multimodal signals (text, audio, emotion), which in turn degrades interaction quality and wastes computing and network resources through repeated, context-unaware generation.

In particular, existing architectures do not provide a unified mechanism by which (a) communication history of the deceased person is analyzed to extract machine-interpretable feature information, (b) this feature information is used to systematically construct prompt sentences that condition a generative artificial intelligence model, (c) user emotion signals are incorporated both at the text-generation stage and at the speech-synthesis stage, and (d) intermediate artifacts such as prompt sentences, generated text, emotion information, and audio data are maintained as session information for subsequent turns. Without such an integrated mechanism, the server cannot reliably maintain persona consistency across a session, cannot efficiently reuse accumulated context, and cannot precisely control speech prosody in a way that matches evolving user emotion. Consequently, the overall computing system remains sub-optimal in terms of model controllability, response coherence, latency, and resource utilization.

Accordingly, there is a need for an improved computer-implemented system in which a processor is specifically configured to (1) derive structured feature information from communication history and call history of a deceased person, (2) construct or configure a generative artificial intelligence model and corresponding prompt sentences using this feature information, (3) generate text responses and speech data that consistently imitate the linguistic and acoustic characteristics of the deceased person, (4) analyze user emotion from voice and image information and dynamically adjust both linguistic content and speech prosody based on the emotion, and (5) store and reuse session-level correspondence among prompts, generated text, emotion information, and audio data. By addressing these technical problems, the invention improves the functioning of servers and dialogue systems that employ generative models and speech synthesis engines, providing more controllable, context-aware, and resource-efficient interaction.

The specific processing by the specific processing unit 290 of the data processing device 12 in Application Example 2 is realized by the following means.

The present invention provides a server comprising a processor and a storage device, the processor being configured to (i) collect, from the storage device, communication history information and call history information associated with a deceased person, and perform information analysis processing including natural language processing on the communication history information and the call history information to extract feature information indicating linguistic characteristics of the deceased person; (ii) construct or configure a generative artificial intelligence model based on the extracted feature information and audio information associated with the deceased person so that the generative artificial intelligence model reflects linguistic characteristics and acoustic characteristics of the deceased person; (iii) generate a prompt sentence, based on request information input from a user via a terminal device and the feature information, the prompt sentence defining at least a situation in which the deceased person responds to the request information, a purpose of a conversation, and a tone of speech; (iv) input the generated prompt sentence and conversation history information into the generative artificial intelligence model and generate text response information that imitates the linguistic characteristics of the deceased person; (v) generate audio data that imitates a voice of the deceased person by using a speech synthesis engine based on the text response information and voice profile information indicating acoustic characteristics of the deceased person; (vi) analyze voice information and image information of the user to extract emotion information indicating an emotional state of the user, and dynamically adjust at least one of content of the text response information and prosody, speaking rate, and volume of the audio data according to the emotion information; (vii) distribute the adjusted audio data to the terminal device via a communication network by streaming distribution or download distribution to provide a dialogue experience with the deceased person to the user; and (viii) store, as session information in the storage device, a correspondence among the prompt sentence, the text response information, the emotion information, and the audio data, and refer to the session information when subsequently generating a response to update at least one of the prompt sentence and the text response information. This enables the computing system to more tightly couple historical feature extraction, generative model conditioning through prompt sentences, emotion-aware response generation, and speech synthesis, thereby improving persona consistency, interaction coherence, and computational efficiency of server-based dialogue services that emulate a deceased person's voice and manner of speaking.

The term “communication history information” refers to text-based or symbol-based records of past exchanges involving a target person, including but not limited to messages, chats, emails, and postings, which are stored in a storage device and can be processed by a computer system.

The term “call history information” refers to records relating to past voice or video calls involving a target person, including metadata such as timestamps and participants, and optionally transcripts or audio data, which are stored in a storage device and made available for analysis by a processor.

The term “deceased person” refers to a human individual who is no longer living and whose past communication history information, call history information, and audio information are used as source data for generating imitative responses and speech.

The term “storage device” refers to any computer-readable medium capable of storing digital information, including, for example, semiconductor memory, magnetic storage, optical storage, or remote storage accessible over a network.

The term “information analysis processing” refers to a series of computer-implemented operations for transforming input data into derived information, including parsing, feature extraction, statistical analysis, and machine learning-based processing.

The term “natural language processing” refers to computational techniques for analyzing and processing human language data, including tokenization, part-of-speech tagging, syntactic parsing, semantic analysis, and generation of language representations usable by machine learning models.

The term “feature information” refers to structured data that represents extracted characteristics from raw data, such as numerical vectors, symbolic labels, or other machine-interpretable descriptors indicating patterns in language, voice, or behavior.

The term “linguistic characteristics” refers to attributes of a person's language usage, including but not limited to vocabulary preferences, phrase patterns, sentence length, formality level, idiomatic expressions, and habitual discourse structures.

The term “audio information” refers to digital data representing sound signals associated with a person, such as recorded speech or other vocalizations, which can be used to derive acoustic characteristics or to construct voice profiles.

The term “acoustic characteristics” refers to properties of a voice signal, such as pitch, timbre, speaking rate, intonation, and energy distribution, which collectively distinguish one speaker's voice from another's.

The term “generative artificial intelligence model” refers to a machine learning model that has been trained to produce new data, such as text or audio, conditioned on input data, and that can generate responses that follow patterns learned from training data.

The term “construct or configure a generative artificial intelligence model” refers to training, fine-tuning, adapting, or parameter-setting of a generative artificial intelligence model so that it behaves according to desired characteristics derived from input data.

The term “voice profile information” refers to data describing acoustic characteristics of a target voice, such as speaker embeddings, prosodic parameters, or synthesis configuration parameters, which are used by a speech synthesis engine to imitate that voice.

The term “request information” refers to input data received from a user that specifies a desired content, topic, or interaction mode, and that serves as a basis for generating a response by the system.

The term “terminal device” refers to any user-operated computing device capable of communicating with a server over a network, including, for example, smartphones, tablet computers, wearable devices, or personal computers.

The term “prompt sentence” refers to a text or structured textual block provided as input to a generative artificial intelligence model, the text specifying role, situation, constraints, or instructions that condition how the model generates output.

The term “conversation history information” refers to data representing past exchanges between a user and the system within a session, including user inputs, generated outputs, and associated metadata, which is used to maintain context for subsequent responses.

The term “text response information” refers to textual data generated by a generative artificial intelligence model in response to input, representing the content that will be presented to the user or converted into speech.

The term “speech synthesis engine” refers to a software component or system that converts text or other intermediate representations into audio data simulating human speech.

The term “audio data” refers to digital data representing sound, typically encoded in a waveform or compressed audio format, which can be output through a speaker or similar device.

The term “voice information of the user” refers to audio data captured from the user's speech or other vocal sounds, which is used by the system for analysis, such as emotion estimation.

The term “image information of the user” refers to visual data, such as still images or video frames capturing the user's face or body, which is used by the system for analysis, including emotion or state estimation.

The term “emotion information” refers to data indicating an inferred emotional state of a user, such as happiness, sadness, anger, or neutrality, and optionally including intensity or temporal characteristics of such states.

The term “prosody” refers to suprasegmental features of speech, including pitch contour, rhythm, stress, and intonation patterns, which affect how speech is perceived beyond its literal text content.

The term “speaking rate” refers to the temporal speed at which speech is produced, typically expressed in units such as syllables or words per unit time.

The term “volume” refers to a perceived loudness level of audio, which can be controlled by adjusting signal amplitude or gain.

The term “dialogue experience” refers to an interactive exchange between a user and the system, perceived by the user as a conversational interaction, including audio output and optionally multimodal feedback.

The term “communication network” refers to any combination of wired or wireless data transmission infrastructure enabling data exchange between devices, including local area networks, wide area networks, and public networks.

The term “streaming distribution” refers to a method of delivering audio data in segments over a network such that playback can begin before all segments are received.

The term “download distribution” refers to a method of delivering audio data by transferring an entire file or a complete data unit to a terminal device before or during playback.

The term “session information” refers to aggregated and structured data representing the state and history of an interaction session, including prompts, generated texts, emotion information, and audio data, stored for use in ongoing or future processing.

The term “representative expressions” refers to phrases or word combinations frequently or distinctively used by a person, which are extracted as characteristic language elements.

The term “speech patterns” refers to recurring structural or stylistic patterns in a person's utterances, such as typical sentence forms, rhetorical devices, or turn-taking styles.

The term “topic tendencies” refers to statistical or qualitative preferences of a person to discuss particular subjects or themes, as inferred from historical communications.

The term “instruction information” refers to additional data added to a prompt sentence or other input, specifying constraints or directives that influence how a generative artificial intelligence model will produce output.

The term “tone” refers to a qualitative style or attitude expressed in language or speech, such as formal, casual, gentle, or enthusiastic, and may be represented in text or controlled in synthesized audio.

The term “tempo” refers to the temporal pacing pattern of synthesized speech, including relative timing between syllables, words, and pauses, which affects perceived speed and rhythm of the output voice.

In one embodiment, a server, a terminal, and a user cooperate to implement the claimed system. The server comprises at least one processor, a main memory, a non-volatile storage device, a network interface, and optionally one or more graphics processing units (GPUs). The terminal comprises a processor, a memory, a microphone, a speaker, optionally a camera, a display, and a network interface. The user operates the terminal to interact with the server over a communication network such as the Internet.

The server stores, in the storage device, communication history information and call history information associated with a deceased person. The communication history information includes message logs, chat records, and other text-based communications. The call history information includes call metadata and, where available, call transcripts and voice recordings. The server uses a database management system, such as a relational database, to organize this information into tables including at least a message table, a call table, a user table, and a deceased profile table. The server stores feature information, prompt sentences, generated responses, emotion information, and audio data identifiers in corresponding tables linked by keys such as deceased identifiers and session identifiers.

The server uses software components implemented in a general-purpose programming language such as a scripting language to process the stored data. The server loads natural language processing libraries, such as a statistical language toolkit or a syntactic/semantic analysis library, to perform information analysis processing. The server tokenizes the communication history information and the call history information, tags parts of speech, identifies named entities, and computes statistical features such as n-gram frequencies, sentence length distributions, and polarity scores. The server then converts each utterance into a numerical vector representation using a language encoder, such as a transformer-based encoder implemented with a machine learning framework. The server aggregates these vectors using operations such as averaging, clustering, and principal component analysis to derive feature information that indicates linguistic characteristics of the deceased person, including representative expressions, speech patterns, and topic tendencies.

The server constructs or configures a generative AI model as follows. The server loads a base generative AI model that is a neural network having a transformer architecture, including multiple self-attention layers, feed-forward layers, and layer normalization. The server associates the feature information with the base model by either fine-tuning model parameters or by configuring adapter modules. In one implementation, the server fine-tunes the generative AI model by performing supervised learning on pairs of input prompts and target texts drawn from the deceased person's communication history. The server uses a loss function such as cross-entropy between predicted token distributions and actual tokens, and the server updates weights using a gradient-based optimizer such as stochastic gradient descent or Adam. The server may apply data augmentation, such as synonym substitution and phrase reordering, to increase robustness. In another implementation, the server maintains the base model fixed and learns lower-dimensional adapter parameters conditioned on the feature information. In both cases, the server stores the resulting parameter sets and associates them with a deceased identifier.

The server uses the feature information to generate a prompt sentence that conditions the generative AI model in a non-generic way. The server maintains a prompt template that defines roles, style constraints, and conversation goals. The server fills the template with data derived from the feature information, such as characteristic phrases, typical topics, and tone descriptors. For example, the server may generate a prompt sentence of the form:
“You are the deceased grandfather speaking to your grandchild. Use simple, warm language and expressions you frequently used, such as ‘back in my day’ and ‘when I was your age’. The grandchild asked: ‘I want to hear an old summer vacation story.’ Please respond with one detailed story in grandfather's style.”

In another example, the server may generate:
“Respond as the deceased mother to her child who is feeling lonely. Use gentle, reassuring phrases and speak in a calm, slow manner. The child said: ‘I miss you a lot these days.’ Please provide a comforting message in mother's voice and style.”

In yet another example, the server may generate:
“Recreate a morning greeting that the deceased friend used to send in messages. Use casual, friendly language, and mention having coffee or heading to work. The user requested: ‘Please recreate our typical morning greeting.’ Generate one or two short greeting sentences in the friend's style.”

The server stores each prompt sentence together with a corresponding session identifier and user identifier. By constructing prompt sentences algorithmically from feature information, the server achieves consistent conditioning of the generative AI model, rather than relying on ad hoc, manually written prompts.

The server invokes the generative AI model by providing the prompt sentence and the conversation history information as input. The conversation history information is stored in a structured format, for example as a sequence of message objects each containing a role field (user or deceased), a timestamp, additional context fields, and text content. The server encodes the prompt sentence and the conversation history information into token sequences and feeds these tokens into the input layer of the generative AI model. The generative AI model performs a sequence of matrix multiplications, attention computations, and non-linear transformations to produce output token distributions at each position. The server decodes these distributions into text tokens using a sampling strategy such as nucleus sampling or temperature-scaled sampling. The server concatenates the generated tokens to form text response information that imitates the linguistic characteristics of the deceased person. Because the input includes structured prompt sentences enriched with feature information, the generative AI model is constrained to generate outputs with the desired style, thus improving persona consistency and reducing variation compared with generic language generation. The server generates audio data using a speech synthesis engine. The server stores voice profile information for each deceased person. The voice profile information includes speaker embeddings generated by a speaker-recognition neural network, statistics of pitch and energy over time, and parameters for a text-to-speech front-end, such as phoneme duration models. The server passes the text response information and the voice profile information to the speech synthesis engine. The speech synthesis engine may be a neural text-to-speech system including a text encoder and a waveform generator, such as a sequence-to-sequence model followed by a vocoder. The server sets engine parameters, including target pitch, speaking rate, and intonation patterns, according to the voice profile information. The speech synthesis engine produces digital audio data, such as a waveform sampled at a specified rate. By using the stored voice profile information, the server ensures that the audio data imitates the acoustic characteristics of the deceased person.

The terminal captures voice information and image information of the user. The terminal uses its microphone to record user speech segments, and uses its camera to capture images or video frames of the user's face. The terminal may perform basic pre-processing, such as encoding audio in a compressed format and scaling images, and transmits the processed data to the server. The server receives this data and performs emotion analysis using an emotion-recognition module. The server may use a convolutional neural network or a recurrent neural network to process audio features such as Mel-frequency cepstral coefficients, and may use a convolutional neural network to process facial images. The server computes emotion logits and normalizes them into probabilities for categories such as joy, sadness, anger, and neutrality. The server then assigns an emotion label and intensity level as emotion information.

The server uses the emotion information to adjust both text response information and audio data in a manner that improves user experience and computational efficiency. The server may modify a subsequent prompt sentence to include explicit instructions regarding tone and content. For example, the server may generate:
“The user is currently sad. Respond as the deceased grandfather in a calm, comforting tone, acknowledging the grandchild's sadness and offering support in grandfather's characteristic style.”

By adding such instructions to the prompt sentence, the server influences the generative AI model to produce output tailored to the user's emotional state, without needing to re-derive style at each turn. The server also modifies parameters of the speech synthesis engine based on the emotion information, for example by lowering speaking rate and pitch when the user is sad, or increasing them when the user is joyful. This dual-stage control, at both the linguistic and acoustic levels, yields a technical effect of reducing the need for post-hoc editing and re-synthesis, thereby reducing computation time and network usage.

The server stores session information in the storage device. The session information includes, for each interaction turn, the prompt sentence used, the text response information generated, the emotion information, links or identifiers of generated audio data, and relevant timestamps. The server organizes session information in a data structure indexed by session identifiers and user identifiers. When the user continues a conversation, the server loads the corresponding session information and uses it to construct new prompt sentences and to provide conversation history information to the generative AI model. This reuse of structured session information causes the model to maintain greater coherence across multiple turns and reduces redundant computation because the server does not need to recompute features from scratch. From a technical standpoint, this design improves memory locality, reduces database access overhead by reusing cached features, and lowers network load by avoiding unnecessary re-transmission of static data.

The server and terminal implement concrete software modules to realize the described functionality. The server includes a feature extraction module, a generative model control module, an emotion analysis module, a speech synthesis control module, a session management module, and a network communication module. The terminal includes a user interface module, an input acquisition module, a media playback module, and optionally a local pre-processing module. Each module exchanges data using defined data structures, such as JSON-like objects or strongly typed records in memory. For example, the feature extraction module outputs a feature vector structure containing arrays of numerical values, a list of representative expressions, and topic identifiers. The generative model control module receives these structures and constructs prompt sentences by combining template strings with values from the structures.

The use of the generative AI model and the prompt sentence construction in this system is not a mere automation of human mental activity. The server executes model training and inference using hardware acceleration and specialized numerical routines that are impractical for humans to replicate. The server performs gradient calculations over large parameter spaces, manages numerical stability in floating-point operations, and employs batch processing techniques that exploit vectorized instructions on the processor or GPU. The server also implements non-conventional data flows by linking feature extraction, prompt construction, emotion conditioning, and speech synthesis into a unified pipeline, instead of treating them as independent steps. By doing so, the server reduces latency by pre-computing and caching feature information, reduces error rates by constraining model outputs with technical conditions embedded in prompt sentences, and reduces data transfer volume by transmitting compressed audio data tailored to the user's emotional state rather than repeatedly transmitting full models or unstructured text.

The architecture of the generative AI model in this system is further configured for the specific technical use of mimicking a deceased person's voice and manner of speaking. The server adjusts model hyperparameters, such as the number of attention heads, sequence length, and hidden layer sizes, to match the typical length and complexity of the deceased person's utterances. The server uses a custom tokenization scheme that preserves certain phrases as single tokens when they are known representative expressions of the deceased person. This non-standard tokenization improves both speed and fidelity, because the model does not need to reconstruct multi-token phrases each time. The server uses a specialized decoding strategy that enforces constraints such as not exceeding predefined length limits and including at least one representative expression when appropriate. These constraints are enforced algorithmically by filtering candidate tokens during decoding, thereby reducing the frequency of undesirable outputs and improving computational efficiency by pruning low-probability sequences early.

The system produces concrete technical effects that go beyond abstract idea implementation. Because the server integrates feature extraction, model conditioning, emotion-aware control, and speech synthesis in a single pipeline, the server can reuse intermediate representations and avoid repeated parsing and encoding. This reduces processing time and energy consumption. The system also reduces network load by streaming audio in segments matched to the user's playback rate and by avoiding full re-transmission of long histories. Furthermore, by storing and reusing session information, the server minimizes redundant access to the underlying communication history information and call history information, improving database throughput. These improvements in processing speed, resource utilization, and response consistency constitute enhancements to the functioning of the computer system itself.

In one alternative embodiment, the server does not fully fine-tune the generative AI model for each deceased person, but instead uses a shared base model and attaches deceased-specific embeddings learned from feature information. The server trains a mapping from feature information to a latent embedding space and uses this embedding as an additional input to each layer of the generative AI model. This approach reduces storage requirements and training time, because the base model weights are shared among multiple profiles and only a small embedding vector per deceased person is stored. In another embodiment, the server can switch between different speech synthesis engines, such as a parametric synthesizer or a neural vocoder, depending on device capabilities and network conditions, to balance audio quality and bandwidth usage.

In still another embodiment, the terminal performs part of the processing, such as local emotion recognition or basic text normalization, to reduce server load and network traffic. The terminal may run a smaller neural network model to estimate coarse emotion categories and send only discrete labels rather than raw audio or video data. The server then refines or directly uses these emotion labels to adjust text generation and speech synthesis. This division of labor between the server and the terminal further enhances scalability and responsiveness of the system.

In all embodiments, the server uses the generative AI model and prompt sentences in a coordinated manner to achieve high-fidelity, emotion-aware imitation of a deceased person's speech. The integration of decomposed feature information, structured prompt construction, emotion-conditioned language generation, and controlled speech synthesis produces reproducible, machine-enforceable improvements in consistency, latency, and computational efficiency, thereby improving the operation of the underlying computer system and meeting technical requirements for practical deployment.

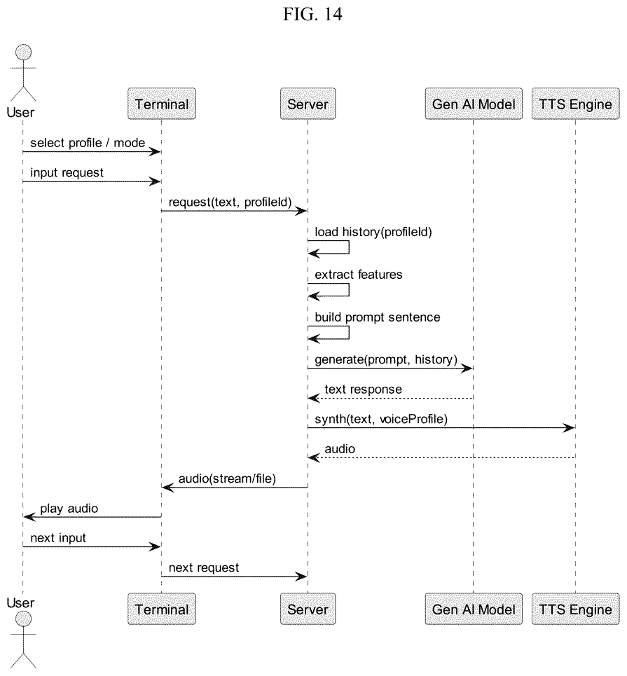

The following describes the processing flow using FIG. 14.
Step 1:

User powers on the terminal and starts an application for interacting with a deceased person's profile.

User selects a deceased person and a desired interaction mode (for example, “story”, “daily chat”, or “greeting”) from a menu displayed on the terminal.

Input: User selection (deceased identifier, interaction mode).

Output: A request message sent from the terminal to the server including the deceased identifier, the interaction mode, and a session identifier.

Terminal packages the deceased identifier and interaction mode into a structured request and transmits the request to the server over a communication network using a communication protocol.
Step 2:

User inputs a natural language request specifying desired content, using text or voice.

Input: User utterance such as “I want to hear an old summer vacation story in my grandfather's voice.”

Output: Text request data sent from the terminal to the server.

Terminal, when receiving text input, reads the character sequence from the user interface and directly uses it as request text.

Terminal, when receiving voice input, records audio via the microphone, converts the analog signal into digital samples, and applies speech-to-text processing using a local or remote recognition engine to obtain a text transcription.

Terminal embeds the text request together with the deceased identifier and session identifier into a request message and sends it to the server.
Step 3:

Server receives the request message and normalizes the user request text.

Input: Request message containing request text, deceased identifier, and session identifier.

Output: Normalized request text and a stored log entry in a database.

Server converts the text to a canonical form by lowercasing, removing unnecessary whitespace, and standardizing punctuation.

Server applies a natural language processing pipeline to segment the text into tokens and detect the language.

Server writes the raw and normalized forms of the request along with user and session identifiers into a request log table in a database, thereby preserving context for future processing.
Step 4:

Server loads communication history information and call history information of the selected deceased person from storage.

Input: Deceased identifier.

Output: A set of historical text records and, where available, call transcripts and audio references.

Server queries a relational database using the deceased identifier as a key to read messages and call logs.

Server, when call transcripts are stored externally, retrieves file paths from the database and then reads transcript text files or audio references from a file storage system.

Server assembles a collection of utterances and metadata (timestamps, interlocutors) in memory for subsequent analysis.
Step 5:

Server performs feature extraction on the historical records to obtain linguistic characteristics of the deceased person.

Input: Historical text records and call transcripts associated with the deceased person.

Output: Feature information representing linguistic characteristics, including vectors, representative expressions, and topic tendencies.

Server uses natural language processing libraries to tokenize sentences, perform part-of-speech tagging, and extract n-gram statistics.

Server computes numerical embeddings for each utterance using a language encoder, such as a transformer-based model, producing vectors of fixed dimension.

Server clusters or averages these vectors to derive a profile vector and extracts frequent phrases and characteristic sentence patterns.

Server stores the feature information in a feature table linked to the deceased identifier so that this information can be reused in later sessions.
Step 6:

Server configures a generative AI model using the feature information.

Input: Feature information for the deceased person and a base generative AI model.

Output: A configured generative AI model specialized or conditioned for the deceased person.

Server loads a pre-trained transformer-based language model into memory (for example, a model with multiple attention layers).

Server either fine-tunes the model weights using the historical records as training data or attaches adapter parameters conditioned on the feature information.

Server performs gradient-based optimization steps, computing loss between predicted tokens and actual tokens, and updates model parameters to better imitate the deceased person's style.

Server registers the resulting parameter set or conditioning vectors in association with the deceased identifier, making a configured generative AI model ready for inference.
Step 7:

Server builds a prompt sentence that instructs the generative AI model how to generate a response.

Input: Normalized request text from the user, feature information of the deceased person, and optionally conversation history information from the current session.

Output: A structured prompt sentence that encodes role, style constraints, and conversation goal.

Server selects a prompt template suitable for the chosen interaction mode (for example, a storytelling template or a greeting template).

Server inserts representative expressions, tone descriptions, and topic cues from the feature information into the template.

Server incorporates the user's request verbatim or in paraphrased form to specify what the deceased person should talk about.

Server generates prompt sentences such as:
“You are the deceased grandfather speaking to your grandchild. Use simple, warm language and expressions you frequently used, such as ‘back in my day’ and ‘when I was your age’. The grandchild asked: ‘I want to hear an old summer vacation story.’ Please respond with one detailed story in grandfather's style.”

Server stores the constructed prompt sentence in a session record for traceability.
Step 8:

Server generates text response information using the configured generative AI model.

Input: Prompt sentence and conversation history information.

Output: Generated text response information that imitates the deceased person's style.

Server encodes the prompt sentence and conversation history into token sequences according to the generative AI model's tokenizer.

Server feeds the tokens into the generative AI model and executes forward passes through the transformer layers, obtaining probability distributions for the next token at each step.

Server applies a decoding algorithm, such as nucleus sampling with a specified temperature and probability threshold, to select tokens from the distributions and build a text sequence.

Server stops generation when an end-of-sequence condition is met or a maximum length is reached, and concatenates the tokens to form a response text.

Server stores the generated text response information in a generated response table linked to the session.
Step 9:

Server prepares or retrieves voice profile information for the deceased person.

Input: Deceased identifier and, where available, recorded audio samples of the deceased person.

Output: Voice profile information describing acoustic characteristics of the deceased person.

Server, when precomputed voice profile information exists, loads the speaker embedding, pitch statistics, and speaking rate parameters from a voice profile table.

Server, when no profile exists, computes a new profile by passing recorded audio samples through a speaker-recognition network to obtain speaker embeddings and by analyzing pitch and energy contours over time.

Server stores or updates the voice profile information so that it can be reused for future synthesis.
Step 10:

Server converts the generated text response information into audio data using a speech synthesis engine.

Input: Text response information and voice profile information.

Output: Audio data that imitates the deceased person's voice.

Server calls a text-to-speech engine, specifying the generated text, the speaker embedding or voice profile ID, and synthesis parameters such as sampling rate and target pitch.

Server passes the text through the TTS front-end to obtain a sequence of phonetic or intermediate representations, and then uses a neural vocoder to generate a waveform.

Server optionally performs audio post-processing such as volume normalization and noise reduction to improve playback quality.

Server stores the generated audio data in a media store and records its location in the session information.
Step 11:

Terminal acquires user emotion signals for emotion-aware adaptation.

Input: User speech during or after playback, and optionally facial images captured by the terminal.

Output: Audio frames and image frames sent from the terminal to the server, or local emotion labels.

Terminal records short segments of user speech with the microphone, digitizes the signals, and optionally extracts audio features such as Mel-frequency coefficients.

Terminal, when a camera is available, captures images or video frames of the user's face and may compress or downscale them.

Terminal sends the captured data or derived feature vectors to the server as emotion analysis input.
Step 12:

Server analyzes user emotion based on received signals.

Input: User voice information and image information.

Output: Emotion information including emotion category and intensity.

Server processes audio data with an audio emotion-recognition network that takes acoustic features as input and outputs probabilities over emotion classes.

Server processes image data with a vision model that detects facial landmarks and classifies expressions into emotion categories.

Server combines audio-based and image-based probabilities, for example by weighted averaging, and selects a dominant emotion label and associated intensity score.

Server records the emotion information in the session information for use in subsequent response generation and speech synthesis.
Step 13:

Server adjusts subsequent prompt sentences and speech parameters according to the emotion information.

Input: Emotion information and current session information including the last response.

Output: An updated prompt sentence and updated speech synthesis parameters.

Server modifies the next prompt sentence by adding explicit instructions regarding tone and content, such as:
“The user is currently sad. Respond as the deceased grandfather in a calm, comforting tone, acknowledging the grandchild's sadness and offering support in grandfather's characteristic style.”

Server updates target pitch, speaking rate, and prosody weights used by the speech synthesis engine, for example by lowering pitch and speed for sadness or increasing them for joy.

Server stores the updated prompt and parameter settings in the session information, enabling consistent emotion-aware behavior across turns.
Step 14:

Server streams or delivers the audio data to the terminal for playback.

Input: Generated or adjusted audio data and session information.

Output: Audio stream or downloadable audio file delivered to the terminal.

Server, in streaming mode, segments the audio data into chunks and sends them sequentially to the terminal using an appropriate protocol so that playback can begin before all data is transferred.

Server, in download mode, sends the entire audio file or a link to the file, allowing the terminal to download before or during playback.

Terminal receives the audio data, buffers it, and plays it through the speaker or headphones, presenting the deceased person's imitative voice to the user.
Step 15:

User continues the interaction and the system updates session information.

Input: User follow-up inputs, ongoing generated responses, and emotion information.

Output: Updated session information stored on the server, including conversation history, prompt sentences, text responses, emotion data, and audio references.

User may respond to what was heard by asking follow-up questions or making comments, such as “Tell me more about that summer” or “What advice would you give me today?”.

Terminal captures and sends these new inputs to the server.

Server appends the new user messages to the conversation history, constructs new prompt sentences incorporating past turns, and repeats the generation, emotion analysis, and synthesis steps.

Server maintains and updates the session information structure, which improves coherence and reduces redundant computation in subsequent steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

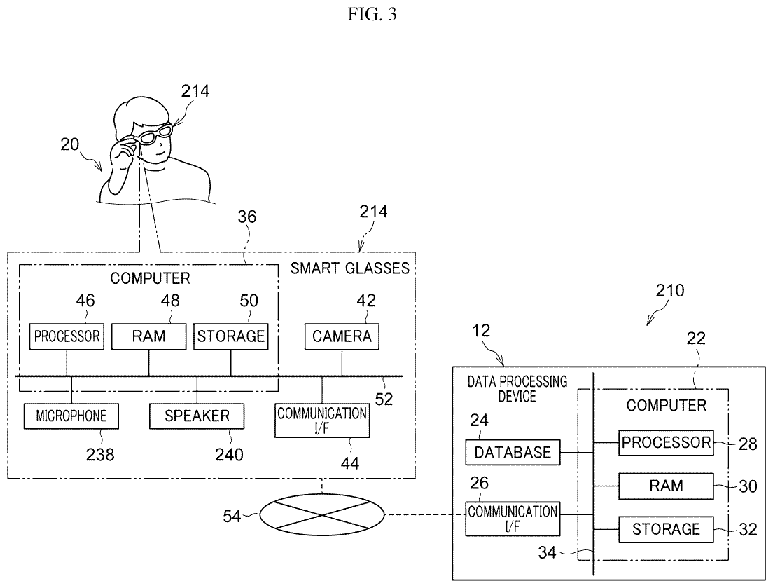

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

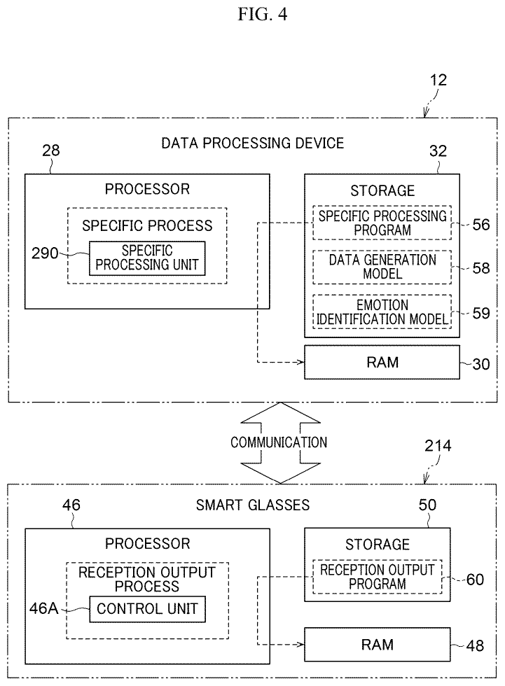

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

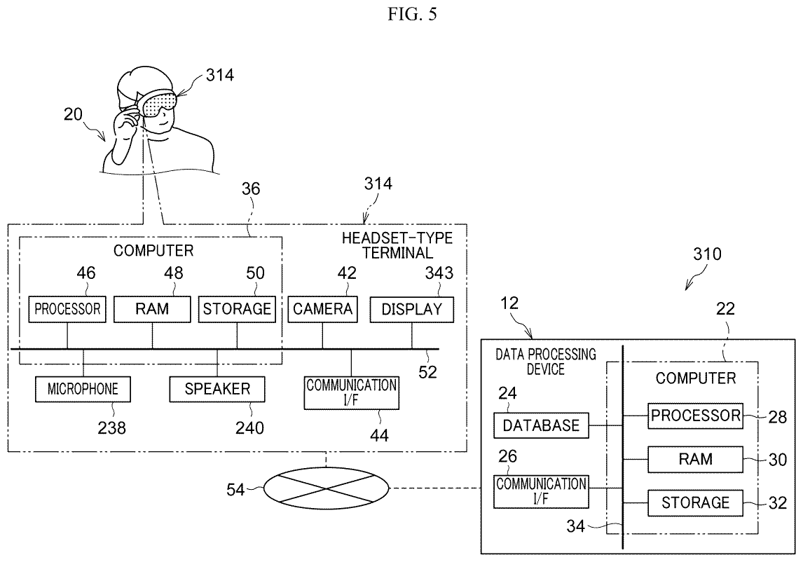

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

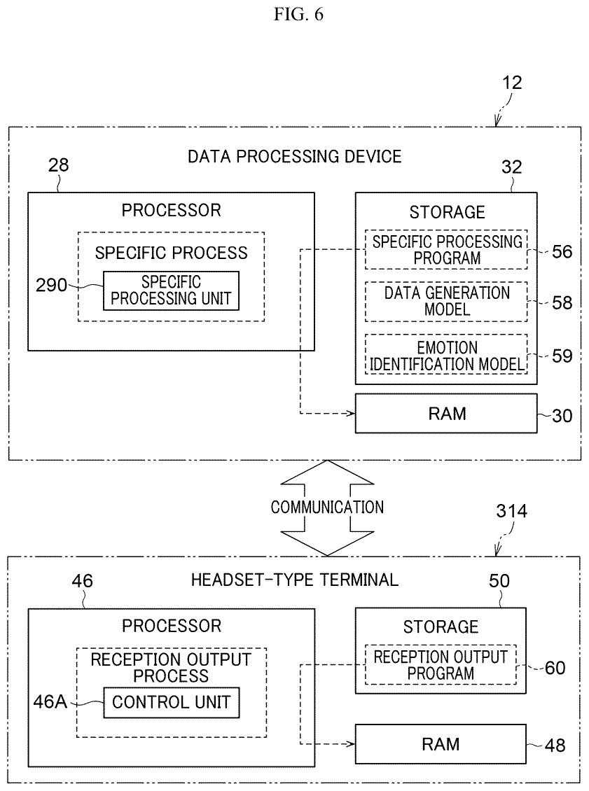

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

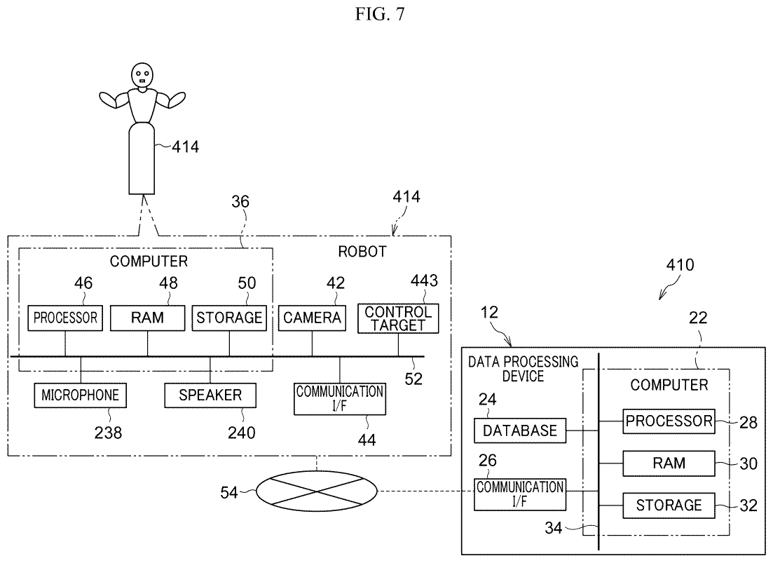

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

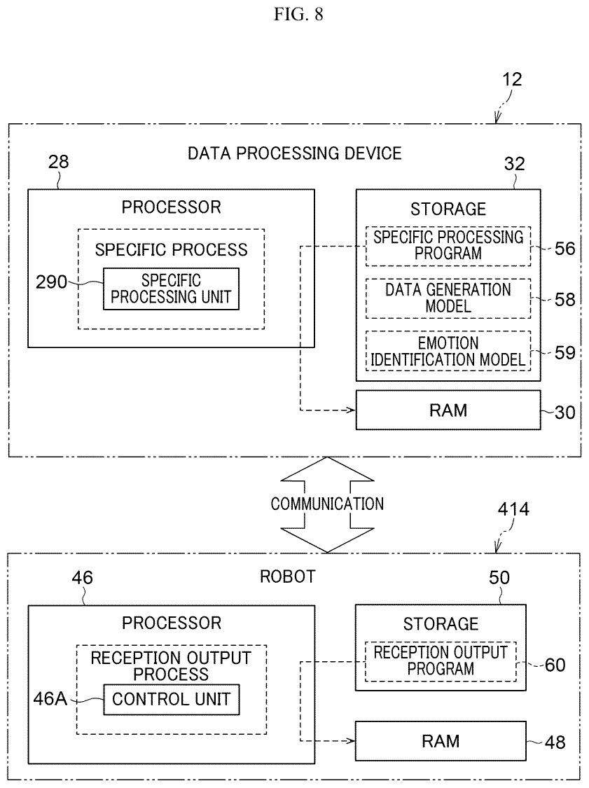

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

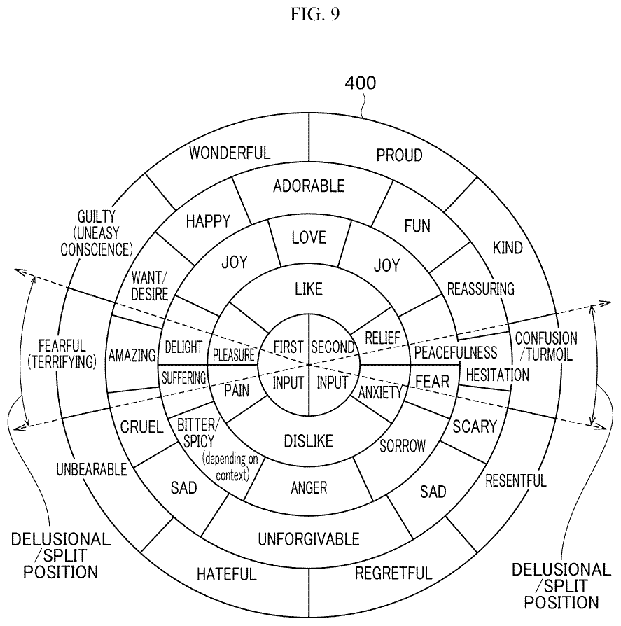

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o′clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

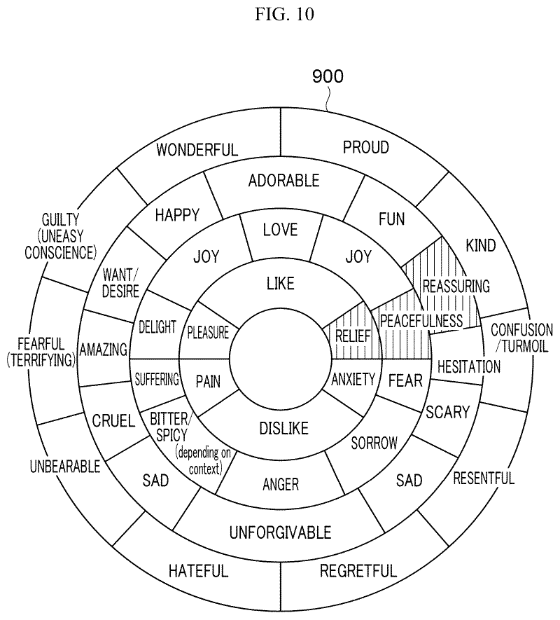

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from a user terminal, communication record data including communication history information and audio record information of a target speaker, and normalize the communication record data into structured data on a conversation basis and a speaker basis and store the structured data in a storage device,
execute natural language processing and audio signal processing on the structured communication record data to extract speaker feature data including lexical selection tendencies, sentence structure patterns, response patterns, and audio feature quantities specific to the target speaker,
construct, by using the speaker feature data and a pre-trained language generation model, a generative artificial intelligence model whose parameters are adjusted so as to conform to an expression style of the target speaker, and store the generative artificial intelligence model for response generation processing,
generate a prompt sentence including at least one of a conversation topic, situation information, and constraint information indicating a target speaker style, based on a natural language input sentence acquired from the user terminal,
input the generated prompt sentence to the generative artificial intelligence model and generate a text response sentence that imitates the expression style of the target speaker by autoregressively generating tokens by the generative artificial intelligence model,
generate an audio response signal based on the text response sentence by using an audio synthesis model and a waveform generation model that reflect the audio feature quantities of the target speaker, and
transmit at least one of the text response sentence and the audio response signal to the user terminal and record the transmitted information as dialogue history information.

### (Supplementary 2)

The system according to supplementary 1,
wherein the processor is configured to execute, as the natural language processing, at least tokenization processing, sentence segmentation processing, emotion estimation processing, and dialogue context extraction processing, and model, as the speaker feature data, the lexical selection tendencies, the sentence structure patterns, and the response patterns based on results of the processing.

### (Supplementary 3)

The system according to supplementary 1,
wherein the processor is configured to add generation conditions indicating at least one of response length, style level, and topic range to the prompt sentence in accordance with the natural language input sentence received from the user terminal, and control an output of the generative artificial intelligence model in accordance with the generation conditions.

### Application Example 1

### (Supplementary 1)

A system comprising a processor,
wherein the processor is configured to
acquire, from a storage device, character information and audio information related to a deceased person, perform preprocessing on the character information by natural language processing to extract linguistic feature information for each utterance unit, and perform preprocessing on the audio information by signal processing to extract acoustic feature information for each utterance unit,
generate, based on the linguistic feature information, a language style model representing vocabulary, expressions, writing style, and thinking patterns characteristic of the deceased person, and generate, based on the acoustic feature information, a voice profile including a speaker embedding representing voice quality and prosody characteristic of the deceased person,
configure or set up a generative AI model for generation processing based on the language style model and the voice profile such that the generative AI model imitates a tone, expressions, and thinking patterns of the deceased person,
generate a prompt sentence for the generative AI model, the prompt sentence specifying a conversation topic, a situation, and a narrative manner, based on input information from a user and the language style model, input the prompt sentence and the input information into the generative AI model, and generate response character information that imitates the tone and expressions of the deceased person,
perform a speech synthesis process to generate a synthesized audio signal that imitates the voice quality and prosody of the deceased person, based on the response character information and the voice profile,
encode the synthesized audio signal into an audio data format capable of being delivered to a user terminal and transmit the encoded audio data to the user terminal through a communication network, and
cause, by control of the user terminal, the user terminal to decode the received audio data and output an audio signal reproducible by an output device of the user terminal.

### (Supplementary 2)

The system according to supplementary 1,
wherein the processor is configured to
calculate vector representations of the character information by using a machine learning model, perform clustering of vocabulary patterns and expression patterns of the deceased person based on the vector representations, and generate the language style model based on a result of the clustering.

### (Supplementary 3)

The system according to supplementary 1,
wherein the processor is configured to
include, in the prompt sentence, typical intonation, emotional tendencies, and frequently used expressions of the deceased person extracted from the language style model, thereby instructing the generative AI model regarding the conversation topic, the situation, and a speaking manner specific to the deceased person.

### Example 2

### (Supplementary 1)

A system comprising a processor,
wherein the processor is configured to
acquire, from an information storage device that stores history information related to a deceased person, audio information and character information related to the deceased person, and perform feature extraction processing on the audio information and the character information to generate feature information representing speaker features and language features of the deceased person, and
construct, on the basis of the feature information, a generative learning model configured to imitate a speech manner, an expression pattern, and a thought pattern of the deceased person, and generate a response text imitating the speech manner of the deceased person by using the generative learning model, and
generate, on the basis of input information acquired from a user, a prompt sentence for instructing the generative learning model regarding content of the response text, a conversation topic, and a conversation situation, and
input the prompt sentence into the generative learning model to cause the generative learning model to output the response text reflecting the speech manner, the expression pattern, and the thought pattern of the deceased person, and
acquire speaker embedding information on the basis of the speaker features included in the feature information, and input the response text and the speaker embedding information into a voice synthesis processing unit to generate an audio signal imitating a voice quality of the deceased person, and
encode the audio signal as audio data and transmit the audio data to a user terminal via a communication path, and
cause the user terminal to decode the audio data and reproduce the audio signal through an acoustic output device so as to present the voice of the deceased person to the user.

### (Supplementary 2)

The system according to supplementary 1,
wherein the processor is configured to
use, as the generative learning model, a generative artificial intelligence model and generate the response text reflecting the language features of the deceased person on the basis of the prompt sentence and the feature information.

### (Supplementary 3)

The system according to supplementary 1,
wherein the processor is configured to
use, as the voice synthesis processing unit, a voice synthesis program that generates the audio signal from text information and speaker embedding information, generate, by using the voice synthesis program, the audio data expressing the response text in the voice quality of the deceased person in real time, and sequentially transmit the audio data to the user terminal.

### Application Example 2

### (Supplementary 1)

A system comprising a processor,
wherein the processor is configured to
collect, from a storage device, communication history information and call history information associated with a deceased person, and perform information analysis processing including natural language processing on the communication history information and the call history information to extract feature information indicating linguistic characteristics of the deceased person,
construct or set up a generative artificial intelligence model based on the extracted feature information and audio information associated with the deceased person so that the generative artificial intelligence model reflects the linguistic characteristics and acoustic characteristics of the deceased person,
generate a prompt sentence, based on request information input from a user via a terminal device and the feature information, the prompt sentence defining at least a situation in which the deceased person responds to the request information, a purpose of a conversation, and a tone of speech,
input the generated prompt sentence and conversation history information into the generative artificial intelligence model and generate text response information that imitates the linguistic characteristics of the deceased person,
generate audio data that imitates a voice of the deceased person by using a speech synthesis engine based on the text response information and voice profile information indicating the acoustic characteristics of the deceased person,
analyze voice information and image information of the user to extract emotion information indicating an emotional state of the user, and dynamically adjust at least one of content of the text response information and prosody, speaking rate, and volume of the audio data according to the emotion information,
provide a dialogue experience with the deceased person to the user by distributing the adjusted audio data to the terminal device via a communication network by streaming distribution or download distribution, and
store, in the storage device as session information, a correspondence among the prompt sentence, the text response information, the emotion information, and the audio data, and refer to the session information when subsequently generating a response to update at least one of the prompt sentence and the text response information.

### (Supplementary 2)

The system according to supplementary 1,
wherein the processor is configured to embed, when generating the prompt sentence, at least one of representative expressions, speech patterns, and topic tendencies of the deceased person included in the feature information into the prompt sentence so as to condition the generative artificial intelligence model to generate the text response information that emphasizes the linguistic characteristics of the deceased person.

### (Supplementary 3)

The system according to supplementary 1,
wherein the processor is configured to add instruction information indicating the emotional state to the prompt sentence based on the emotion information of the user, change a tone and content of the text response information obtained from the generative artificial intelligence model according to the emotional state of the user, and control parameters of the speech synthesis engine when generating the audio data for the changed text response information so as to adjust a tone and a tempo of a synthesized voice of the deceased person according to the emotion information.

What is claimed is:

1. A system comprising:
a communication interface connected to a packet-switched network; and
circuitry configured to:
acquire, from a data storage device, communication record data associated with a reference speaker, the communication record data comprising at least character-based communication history data and audio record data;
normalize the communication record data into structured data organized on a conversation basis and a speaker basis;
execute natural-language processing on the character-based communication history data to extract linguistic feature data comprising lexical selection tendencies, sentence structure patterns, and response patterns specific to the reference speaker;
execute audio signal processing on the audio record data to extract acoustic feature data comprising audio feature quantities specific to the reference speaker;
construct, using the linguistic feature data and the acoustic feature data in combination with a pre-trained language generation model, a speaker-adapted generative neural network model whose parameters are adjusted to conform to an expression style of the reference speaker;
receive, via the communication interface, input data comprising a natural-language input from a terminal device;
generate a prompt data structure based on the input data, the prompt data structure including at least one of a conversation topic indicator, situation information, and a constraint parameter indicating the expression style;
transmit the prompt data structure to the speaker-adapted generative neural network model and receive, from the speaker-adapted generative neural network model, response data comprising a text output generated by autoregressive token generation that imitates the expression style of the reference speaker; and
transmit the response data to the terminal device via the communication interface.

2. The system according to claim 1, wherein the circuitry is further configured to:
generate, based on the response data and the acoustic feature data, a synthesized audio signal using a speech synthesis model configured with a speaker embedding representing voice quality and prosody of the reference speaker; and
transmit the synthesized audio signal to the terminal device via the communication interface.

3. The system according to claim 2, wherein the speech synthesis model comprises a waveform generation model that converts the text output into the synthesized audio signal by applying the speaker embedding during waveform synthesis.

4. The system according to claim 2, wherein the circuitry is further configured to encode the synthesized audio signal into an audio data format and transmit the encoded audio data to the terminal device through the packet-switched network.

5. The system according to claim 1, wherein executing the natural-language processing comprises performing at least tokenization processing, sentence segmentation processing, emotion estimation processing, and dialogue context extraction processing on the character-based communication history data.

6. The system according to claim 1, wherein the circuitry is further configured to:
compute vector representations of the character-based communication history data using a machine learning model;
perform clustering of vocabulary patterns and expression patterns based on the vector representations; and
generate a language style model based on a result of the clustering, the language style model being used in construction of the prompt data structure.

7. The system according to claim 6, wherein the prompt data structure includes typical intonation indicators, emotional tendencies, and frequently used expressions extracted from the language style model.

8. The system according to claim 1, wherein the circuitry is further configured to:
add generation condition parameters to the prompt data structure, the generation condition parameters indicating at least one of a response length, a style level, and a topic range; and
control an output of the speaker-adapted generative neural network model in accordance with the generation condition parameters.

9. The system according to claim 1, wherein the speaker-adapted generative neural network model comprises a transformer architecture including an embedding layer, a plurality of self-attention layers, a plurality of feed-forward layers, and an output projection layer, parameters of which have been adjusted using the linguistic feature data.

10. The system according to claim 1, wherein the circuitry is further configured to:
estimate an emotional state of a user based on at least one of voice data, image data, and text data received from the terminal device; and
include the emotional state in the prompt data structure to cause the speaker-adapted generative neural network model to adjust at least one of a tone, an emotional expression level, and a degree of empathy in the response data.

11. The system according to claim 10, wherein the emotional state is estimated using an emotion identification model that maps input data to emotion values on an emotion map in which a plurality of emotions are arranged based on a structure giving rise to the emotions.

12. The system according to claim 1, wherein the circuitry is further configured to:
record the prompt data structure, the response data, and feedback information received from the terminal device as dialogue history data in the data storage device; and
update, based on the dialogue history data, at least one of a parameter of the speaker-adapted generative neural network model and a generation rule for the prompt data structure.

13. The system according to claim 1, wherein the circuitry is further configured to:
receive, via the communication interface, a multi-turn conversation comprising a sequence of input data items from the terminal device; and
include, in the prompt data structure for each subsequent input data item in the sequence, context information derived from prior response data and prior input data items.

14. The system according to claim 1, wherein the circuitry is further configured to:
perform speaker diarization on the audio record data to separate audio segments attributed to the reference speaker from audio segments attributed to other speakers; and
extract the acoustic feature data exclusively from the audio segments attributed to the reference speaker.

15. The system according to claim 1, wherein the reference speaker is a deceased person whose communication record data is stored in the data storage device, and the speaker-adapted generative neural network model is configured to reproduce a conversational manner of the deceased person.

16. The system according to claim 1, wherein the circuitry is further configured to:
receive, via the communication interface, an image of the reference speaker; and
generate, using an image generation model conditioned on the response data, a visual output synchronized with the response data for display on the terminal device.

17. The system according to claim 1, wherein the circuitry is further configured to:
apply a safety filter to the response data to suppress content that exceeds a predetermined sensitivity threshold; and
replace suppressed content with alternative content generated by the speaker-adapted generative neural network model under a constrained generation mode.

18. A system comprising:
a communication interface connected to a packet-switched network;
a data storage device; and
circuitry configured to:
acquire, from the data storage device, communication record data associated with a reference speaker;
extract, by natural-language processing and audio signal processing, linguistic feature data and acoustic feature data specific to the reference speaker;
construct a speaker-adapted generative neural network model based on the linguistic feature data and the acoustic feature data;
receive, via the communication interface, input data from a terminal device;
generate a prompt data structure based on the input data and a language style model derived from the linguistic feature data;
transmit the prompt data structure to the speaker-adapted generative neural network model and receive response data imitating an expression style of the reference speaker;
generate a synthesized audio signal based on the response data and the acoustic feature data; and
transmit at least one of the response data and the synthesized audio signal to the terminal device via the communication interface.

19. A method comprising:
acquiring, by circuitry, from a data storage device, communication record data associated with a reference speaker, the communication record data comprising character-based communication history data and audio record data;
executing, by the circuitry, natural-language processing on the character-based communication history data to extract linguistic feature data specific to the reference speaker;
executing, by the circuitry, audio signal processing on the audio record data to extract acoustic feature data specific to the reference speaker;
constructing, by the circuitry, a speaker-adapted generative neural network model based on the linguistic feature data and the acoustic feature data;
receiving, via a communication interface connected to a packet-switched network, input data from a terminal device;
generating, by the circuitry, a prompt data structure based on the input data;
transmitting the prompt data structure to the speaker-adapted generative neural network model and receiving response data comprising a text output that imitates an expression style of the reference speaker; and
transmitting the response data to the terminal device via the communication interface.
